(19) United States
(12) Patent Application Publication
(10) Pub. No.: US 2014/0009695 A1
(43) Pub. Date: Jan. 9, 2014

(54) ILLUMINATION DEVICE, DISPLAY DEVICE, AND TELEVISION RECEPTION DEVICE

(71) Applicant: Yasumori Kuromizu, Osaka (JP)

(72) Inventor: Yasumori Kuromizu, Osaka (JP)

(73) Assignee: SHARP KABUSHIKI KAISHA, Osaka (JP)

(21) Appl. No.: 14/005,117

(22) PCT Filed: Apr. 2, 2012
(86) PCT No.: PCT/JP2012/058913

§ 371 Date: Sep. 13, 2013

(30) Foreign Application Priority Data
Mar. 31, 2011 (JP) 2011-079982

(51) Int. Cl. F21V 23/00; F21V 13/04; F21V 5/00

(52) U.S. Cl. CPC F21V 23/002; F21V 5/007; F21V 13/04
USPC 348/790; 362/249.01; 362/240; 362/249.02; 362/97.1; 349/61

(57) ABSTRACT

A backlight device of the present invention is provided with: a chassis having a bottom plate (22a) and a side plate; LED substrates (25) disposed on the bottom plate (22a) of the chassis in a manner so that one end face and the side plate face each other; LEDs disposed on the LED substrates (25); patterned wiring (35) electrically connected to the LEDs and disposed on the LED substrates (25); a first connector part (31) electrically connected to the patterned wiring (35) and disposed on, of respective end portions of the LED substrates (25), an end portion that has the one end face; a second connector part (32) electrically connected to the first connector part (31) with a connecting direction that is along the plane of the bottom plate (22a), the connecting direction also being, in a plan view, a direction parallel to a first side edge (22a1) that faces the one end face, or a direction directed from the side edge (22a1) toward the end portion (25b) that has the one end face at an acute angle with respect to the first side edge (22a1); and power source wiring (38) electrically connected to the second connector part (32).

### TECHNICAL FIELD

The present invention relates to an illumination device, a display device, and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. Liquid crystal panels used in liquid crystal display devices do not emit light on their own, and therefore, it is necessary to provide a separate backlight device as an illumination device.

One of known backlight devices is a direct lighting type backlight device in which light is directly supplied to the liquid crystal panel from the rear surface thereof. In such a direct lighting type backlight device, a light source substrate having light sources such as LEDs disposed thereon is provided along a bottom plate of a chassis that is used as a case. On the light source substrate, a wiring pattern for electrically connecting the respective light sources to each other is formed, and terminals provided at both ends of the wiring pattern are electrically connected to connectors that are provided at respective ends of a power supply wiring line extending from a power supply substrate. In this way, power is supplied to the respective power sources from the power supply substrate through the connectors. Patent Document 1, for example, discloses an example of such a conventional direct lighting type backlight device.

### RELATED ART DOCUMENT

### Patent Document

Patent Document 1: Japanese Patent Application Laid-Open Publication No. 2010-230951

### Problems to be Solved by the Invention

When a large image display device is realized by arranging a plurality of display devices adjacent to each other, and the like, it is preferable that outer edges of each display device be made less noticeable. In order to make the outer edges of the display device less noticeable in the direct lighting type backlight device in which a display region corresponds in position to a region where the light sources are disposed, it is necessary to reduce the width of a non-display region that surrounds the display region, or in other words, it is necessary to make a frame region narrower.

In the backlight device disclosed in Patent Document 1 above, one end face of the light source substrate is disposed to face one side plate of the chassis in a parallel manner, and a connector is connected to the wiring pattern on an end portion of the light source substrate having that one end face. The connector is connected to the wiring pattern in a connecting direction that is a direction directed from the one side plate toward the one end face perpendicularly to the one end face (direction forming a right angle with the one end face).

By connecting the connector to the wiring pattern in such a connecting direction, in the backlight device disclosed in Patent Document 1, the connector and power supply wiring lines are disposed between the one side plate and the one end face. Therefore, in order to accommodate the connector connected to the wiring pattern and the power supply wiring lines extending from the connector within the chassis, it was necessary to provide a certain space between the one side plate and the one end face. However, if the space between the one side plate of the chassis and the one end face of the light source substrate is made larger, the width of the non-display region is also made larger, which did not allow the frame region of the backlight device to be made narrower.

### SUMMARY OF THE INVENTION

The present invention was made taking into account the above-mentioned problems. An object of the present invention is to provide a technology that allows a frame region to be made narrower, in a direct lighting type illumination device in which power supply wiring lines are connected to a light source substrate at an end portion thereof.

### Means for Solving the Problems

The present invention relates to an illumination device that includes: a housing member that has a bottom plate and a side plate that rises from at least one of side edges of the bottom plate on a side of one surface of the bottom plate, the housing member having a light-emitting section on the side of one surface; a light source substrate disposed on the bottom plate of the housing member such that one end face of the light source substrate faces the side plate; light sources disposed on the light source substrate such that light is emitted toward the light-emitting section of the housing member; patterned wiring disposed on the light source substrate and electrically connected to the light sources; a first connecting member electrically connected to the patterned wiring and disposed on, of end portions of the light source substrate, an end portion that has the one end face; a second connecting member electrically connected to the first connecting member in a connecting direction along a plane of the bottom surface, the connecting direction also being, in a plan view, a direction parallel to the side edge where the side plate facing the one end face is disposed, or a direction directed from that side edge toward the end portion that has the one end face at an acute angle with respect to that side edge; and a power supply wiring line electrically connected to the second connecting member and supplying power to the light sources through the second connecting member, the first connecting member, and the patterned wiring.

With the illumination device described above, by connecting the first connecting member and the second connecting member in the above-mentioned connecting direction, the second connecting member can be made less likely to be disposed between the side plate of the housing member and the one end face of the light source substrate, as compared with the case in which the connecting direction is a direction directed from the side edge where the side plate facing the one end face of the light source substrate toward the one end face at a right angle with respect to the side edge. Therefore, because the second connecting member does not make it difficult for the side plate of the housing member to be made closer to the one end face of the light source substrate (inner side of the housing member), the distance between the side plate of the housing member and the one end face of the light source substrate can be reduced. As a result, it is possible to make a frame region narrower in a direct lighting type illumination device in which power supply wiring lines are connected to a light source substrate at an end portion thereof. The connecting member is not limited to a connector. For example, the connecting member may be a card-type connector in which one connecting member is a terminal that has exposed electrode terminals, and the other connecting member can be connected to the terminal.

The illumination device may be configured such that: the bottom plate is in a horizontally long rectangular shape; the side edges include a pair of first side edges along the short side direction of the bottom plate and a pair of second side edges along the long side direction of the bottom plate; a plurality of the light source substrates are disposed on the bottom plate such that respective one end faces thereof face the side plates that rise from the first side edges; the plurality of light source substrates each have the first connecting member disposed thereon; and a plurality of the first connecting members each have the second connecting member connected thereto.

With this configuration, in the illumination device in which a plurality of light source substrates are disposed on the bottom plate, the distance between the side plates that rise from the first side edges and the respective one end faces of the light source substrates can be reduced, and the frame region of the illumination device can be made narrower.

The plurality of second connecting members may be connected to the respective first connecting members in the same direction.

With this configuration, when connecting the respective first connecting members to the respective second connecting members in the manufacturing process of the illumination device, the connecting work can be conducted in one direction for all connectors.

The illumination device may be configured such that the plurality of light source substrates are disposed in rows along the short side direction of the bottom plate, and the plurality of second connecting members are connected to the respective first connecting members in directions from the respective second side edges toward the center of the bottom plate in the short side direction.

With this configuration, when connecting the respective second connecting members to the respective first connecting members in the manufacturing process of the illumination device, it is possible to conduct the connecting work in two difference directions from two sides.

The illumination device may be configured such that the plurality of light source substrates are disposed in rows along the short side direction of the bottom plate, and the plurality of second connecting members are connected to the respective first connecting members in directions from the center of the bottom plate in the short side direction toward the respective second side edges.

With this configuration, the respective power supply wiring lines connected to the second connecting members are oriented toward the center of the bottom plate in the short side direction, and therefore, it is possible to draw the power supply wiring lines toward the center of the bottom plate in the short side direction with ease. Also, because second connecting members that are positioned closest to the pair of second side edges are not disposed between the light source substrates and the side plates that rise form the second side edges, the pair of the second side edges can be made closer to the light source substrates (inner side), respectively, and the distance between the side plates that rise from the second side edges and the light source substrates can be reduced. As a result, the frame region of the illumination device can be made even narrower.

The plurality of second connecting members may connected to the respective first connecting members in a direction from one side edge of the pair of second side edges toward the other side edge, and the connecting direction may be adjusted in accordance with the distance from the one side edge.

The respective power supply wiring lines are bundles up at several locations inside the housing member, and are drawn to the rear side of the housing member. As it is further away from the locations where the power supply wiring lines are bundled, the power supply wiring lines are pulled toward these locations more strongly. According to the above-mentioned configuration, if the power supply wiring lines are bundled near the other side edge of the pair of second side edges, the connecting direction between the first connecting members and the second connecting members can be adjusted such that the connecting direction is inclined more toward the location where the power supply wiring lines are bundled as it is further away from such a location (as it is closer to the one side edge of the pair of second side edges). As a result, it is possible to prevent an excessive force to be applied to portions of the power supply wiring lines that are further away from the above-mentioned locations, and in the manufacturing process of the illumination device, the power supply wiring lines can be drawn to such locations with greater ease.

The illumination device may further include diffusion lenses disposed on the respective plurality of light source substrates, the diffusion lenses covering light-emitting sides of the light sources and diffusing light from the light sources.

With this configuration, by having light from the light sources pass through the diffusion lenses, the light from the light sources is diffused, and the directivity thereof is lessened. Therefore, even when the number of light sources is reduced, a prescribed brightness can be maintained in the illumination device.

The illumination device may further include a reflective sheet that has a bottom section laid over the light source substrates, lens insertion holes disposed in the bottom section and having the diffusion lenses respectively inserted therethrough, and inclined sections that rise toward the light-emitting section of the housing member near the side plates of the housing member, and among a plurality of the second connecting members, the second connecting members that are respectively closest to the second side edges may be positioned between the reflective sheet and the side plates that rise from the first side edges.

With this configuration, light emitted from the light sources and travelling toward the inclined sections of the reflective sheet is not blocked by the first connecting members or the second connecting members, and therefore, it is possible to improve the light utilization efficiency of the light emitted from the light sources.

The illumination device may be configured such that: the bottom section of the reflective sheet is formed in a horizontally long rectangular shape, and is placed on the light source substrates such that short sides thereof extend along the first side edges and long sides thereof extend along the second side edges; the inclined sections of the reflective sheet include first inclined sections that rise from outer edges along the short sides of the bottom section toward the light-emitting section of the housing member, and second inclined sections that rise from outer edges along the long sides of the bottom section toward the light-emitting section of the housing member, and, among the plurality of second connecting members, second connecting members that are respectively closest to the second side edges are positioned between the first inclined sections of the reflective sheet and the side plates that rise from the first side edges.

In the configuration in which the respective one end faces of the light source substrates face the first side edges, the second connecting members are disposed on respective end portions of the light source substrates having the one end faces, and therefore, in general, the first inclined sections of the reflective sheet are inclined at a smaller angle as compared with the second inclined sections. Thus, because the second inclined sections are inclined at a smaller inclination angle as compared with the first inclined sections, if the second connecting members positioned closest to the respective second side edges are disposed so as to go over the boundaries between the first inclined sections and the second inclined sections between the reflective sheet and the side plates of the housing member, a portion of the second connecting member may make contact with the first inclined section, thereby possibly causing the inclination angle of the first inclined section to change or the like. With the above-mentioned configuration, because the second connecting members are disposed between the first inclined sections and the side plates that rise from the first side edges, it is possible to prevent the portion of the second connecting members from making contact with the first inclined sections.

The acute angle may be in a range of 30° to 60°.

With this configuration, the second connecting member can be connected to the first connecting member with greater ease.

The light sources may be white diodes.

With this configuration, it is possible to extend the life of the light sources and reduce the power consumption thereof.

The white light-emitting diodes may be each made of any one of combinations that include: a combination of a first light-emitting chip that emits blue light and a first light-emitting layer disposed around the first light-emitting chip and having a luminescence peak in a yellow region; a combination of the first light-emitting chip that emits blue light and a second light-emitting layer disposed around the first light-emitting chip and having luminescence peaks in a green region and a red region, respectively; a combination of the first light-emitting chip that emits blue light, a third light-emitting layer disposed around the first light-emitting chip and having a luminescence peak in a green region, and a second light-emitting chip that emits red light; a combination of the first light-emitting chip that emits blue light, the second light-emitting chip that emits red light, and a third light-emitting chip that emits green light; and a combination of a fourth light-emitting chip that emits ultraviolet light, and a fourth light-emitting layer disposed around the fourth light-emitting chip and having luminescence peaks in a blue region and a red region.

With this configuration, the color tone can even out as a whole, and illumination light with a substantially even color tone can be achieved.

The present invention can also be expressed as a display device that includes a display panel that conducts display using light from the above-mentioned illumination device. Also, a display device that uses a liquid crystal panel that uses liquid crystal as the display panel is novel and useful. A television receiver that includes the above-mentioned display device is also novel and useful.

### EFFECTS OF THE INVENTION

According to the present invention, it is possible to make a frame region narrower in a direct lighting type illumination device in which power supply wiring lines are connected to light source substrates at an end portion thereof.

### BRIEF DESCRIPTION OF THE DRAWINGS

FIG. 1 is an exploded perspective view of a television receiver TV according to Embodiment 1.

FIG. 2 is an exploded perspective view of a liquid crystal display device 10.

FIG. 3 is a cross-sectional view of a liquid crystal panel 11 along the long side direction.

FIG. 4 is an enlarged plan view of an array substrate 11b.

FIG. 5 is an enlarged plan view of a CF substrate 11a.

FIG. 6 is a plan view showing an arrangement of diffusion lenses 27, LED substrates 25, supporting members 28, and the like in a chassis 22 provided in a backlight device 12.

FIG. 7 is a cross-sectional view of the liquid crystal display device 10 along the short side direction.

FIG. 8 is a cross-sectional view of the liquid crystal display device 10 along the long side direction.

FIG. 9 is a plan view showing a bottom plate 22a of the chassis 22 and an arrangement of first connector parts 31, second connector parts 32, and the like in respective LED substrates 25.

FIG. 10 is an enlarged plan view showing an end portion 25b having one end face 25a of the LED substrate 25, and a connecting direction of a second connector part 32 that is connected to a first connector part 31 on the end portion 25b.

FIG. 11 is a plan view showing a bottom plate 122a of a chassis 122 and an arrangement of first connector parts 131, second connector parts 132, and the like in respective LED substrates 125 in Embodiment 2.

FIG. 12 is a plan view showing a bottom plate 222a of a chassis 222 and an arrangement of first connector parts 231, second connector parts 232, and the like in respective LED substrates 225 in Embodiment 3.

FIG. 13 is a plan view showing a bottom plate 322a of a chassis 322 and an arrangement of first connector parts 331, second connector parts 332, and the like in respective LED substrates 325 in Embodiment 4.

FIG. 14 is a plan view showing a bottom plate 422a of a chassis 422 and an arrangement of first connector parts 431, second connector parts 432, and the like in respective LED substrates 425 in Embodiment 5.

FIG. 15 is an enlarged plan view showing an end portion 425b having one end face 425a of the LED substrate 425, and a connecting direction of a second connector part 432 that is connected to a first connector part 431 on the end portion 425b.

FIG. 16 is a plan view showing a bottom plate 522a of a chassis 522 and an arrangement of first connector parts 531, second connector parts 532, and the like in respective LED substrates 525 in Embodiment 6.

FIG. 17 is an enlarged plan view showing an arrangement of second connector parts 532 and inclined sections 529b1 and 529b2 of a reflective sheet 529.

FIG. 18 is a plan view showing a bottom plate 622a of a chassis 622 and an arrangement of first connector parts 631, second connector parts 632, and the like in respective LED substrates 625 in Embodiment 7.

FIG. 19 is a plan view showing a bottom plate 722a of a chassis 722 and an arrangement of first connector parts 731, second connector parts 732, and the like in respective LED substrates 725 in Embodiment 8.

FIG. 20 is an enlarged plan view showing an end portion 825b having one end face 825a of an LED substrate 825, and a connecting direction of a card connector 832 that is connected to a terminal 831 extending from the end portion 825b in Embodiment 9.

FIG. 21 is an enlarged plan view showing an end portion 925b having one end face 925a of an LED substrate 925, and a connecting direction of a card connector 932 that is connected to a terminal 931 extending from the end portion 925b in Embodiment 10.

FIG. 22 is an enlarged plan view of a CF substrate according to Modification Example 1.

FIG. 23 is an enlarged plan view of a CF substrate according to Modification Example 2.

FIG. 24 is an enlarged plan view of a CF substrate according to Modification Example 3.

FIG. 25 is an enlarged plan view of a CF substrate according to Modification Example 4.

FIG. 26 is an enlarged plan view of a CF substrate according to Modification Example 5.

FIG. 27 is an enlarged plan view of a CF substrate according to Modification Example 6.

FIG. 28 is an enlarged plan view of an array substrate according to Modification Example 6.

FIG. 29 is an enlarged plan view of a CF substrate according to Modification Example 7.

FIG. 30 is an enlarged plan view of a CF substrate according to Modification Example 8.

FIG. 31 is an enlarged plan view of an array substrate according to Modification Example 8.

FIG. 32 is an enlarged plan view of a CF substrate according to Modification Example 9.

FIG. 33 is an enlarged plan view of an array substrate according to Modification Example 10.

FIG. 34 is an enlarged plan view of a CF substrate according to Modification Example 10.

### DETAILED DESCRIPTION OF EMBODIMENTS

### Embodiment 1

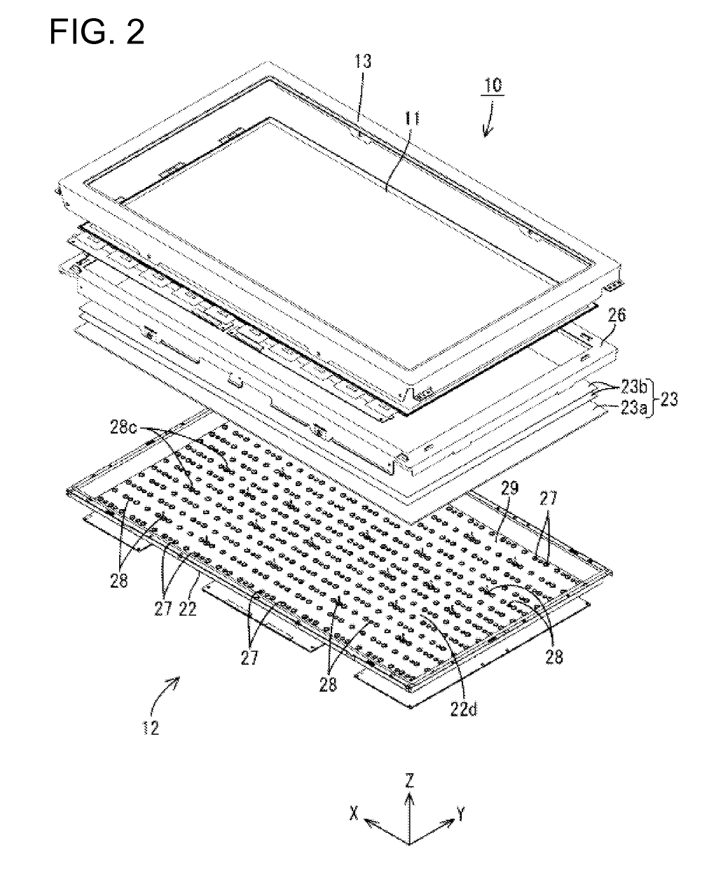

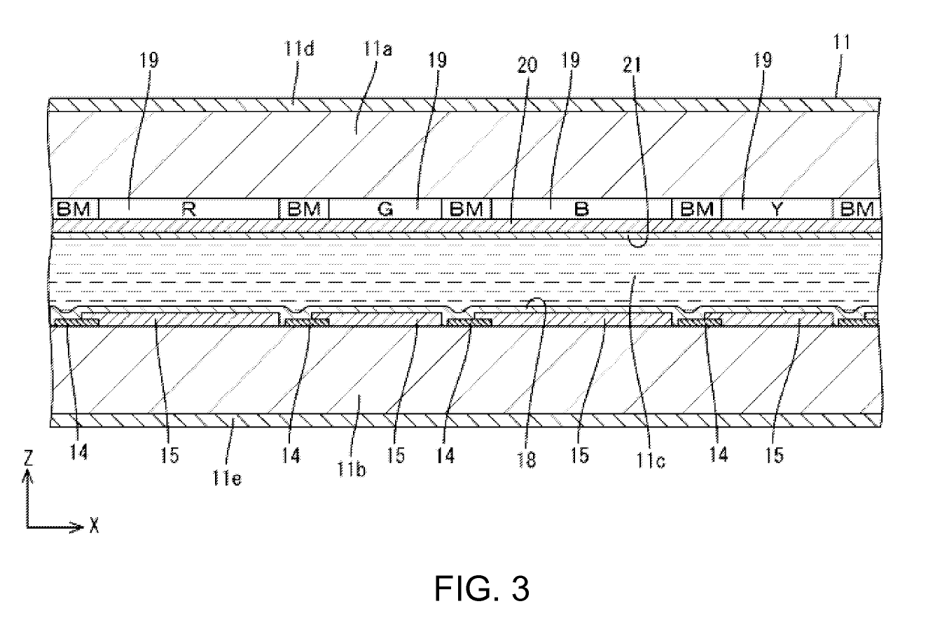

Embodiment 1 will be described with reference to the drawings. In the present embodiment, a liquid crystal display device 10 will be described as an example. The drawings indicate an X axis, a Y axis, and a Z axis in a portion of the drawings, and each of the axes indicates the same direction for the respective drawings. The top side of FIGS. 2 and 3 is the front side, and the bottom side of FIGS. 2 and 3 is the rear side.

(Television Receiver)

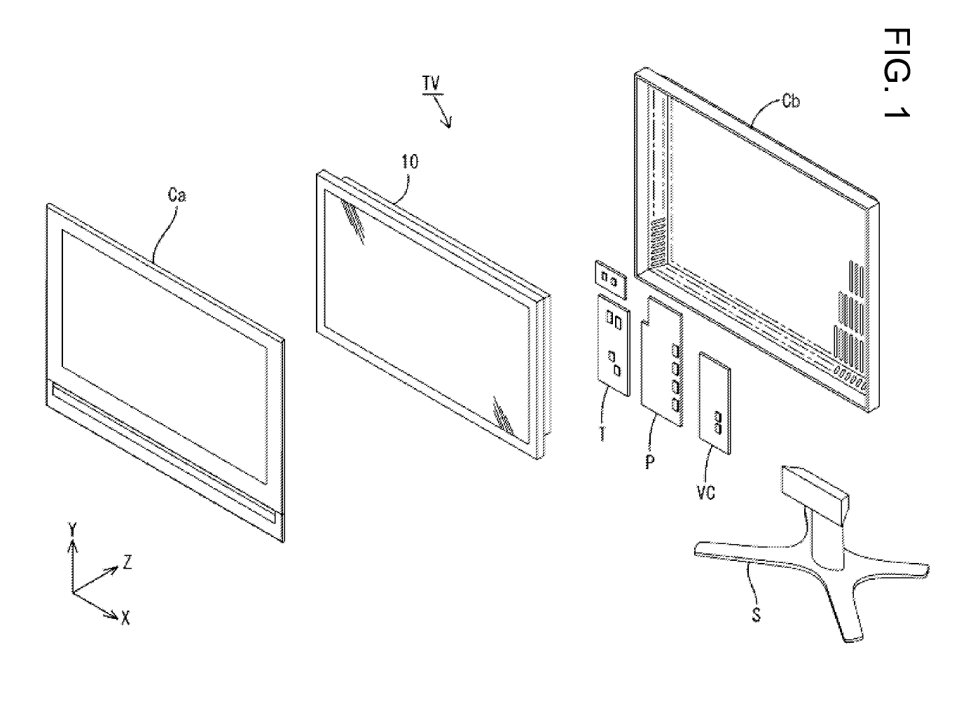

As shown in FIG. 1, a television receiver TV according to the present embodiment includes a liquid crystal display device 10 that is a display device, front and rear cabinets Ca and Cb that store the liquid crystal display device 10 by sandwiching it therebetween, a power supply circuit substrate P for supplying power, a tuner (receiving part) T that can receive television image signals, an image conversion circuit substrate VC that converts the television image signals outputted from the tuner T to image signals for the liquid crystal display device 10, and a stand S.

The liquid crystal display device 10 is formed in a horizontally long quadrangular (rectangular) shape as a whole, and is disposed such that the long side direction thereof matches the horizontal direction (X axis direction) and the short side direction thereof matches the vertical direction (Y direction), respectively. As shown in FIG. 2, the liquid crystal display device 10 includes a liquid crystal panel 11 that is a display panel, and a backlight device (an example of an illumination device) 12 that is an external light source, and these are held together as one component by a frame-shaped bezel 13 and the like.

(Liquid Crystal Panel)

A configuration of the liquid crystal panel 11 in the liquid crystal display device 10 will be explained. The liquid crystal panel 11 is formed in a horizontally long quadrangular (rectangular) shape as a whole, and, as shown in FIG. 3, includes a pair of transparent (having light transmittance) glass substrates 11a and 11b, and a liquid crystal layer 11c disposed between the two substrates 11a and 11b and including liquid crystal that is a substance that changes optical characteristics thereof as a result of being applied with an electric field. The two substrates 11a and 11b are bonded to each other by a not-shown sealing agent while maintaining a gap that corresponds to the thickness of the liquid crystal layer. On the respective outer surfaces of the two substrates 11a and 11b, polarizing plates 11d and 11e are bonded. The long side direction of the liquid crystal panel 11 matches the X axis direction, and the short side direction thereof matches the Y axis direction.

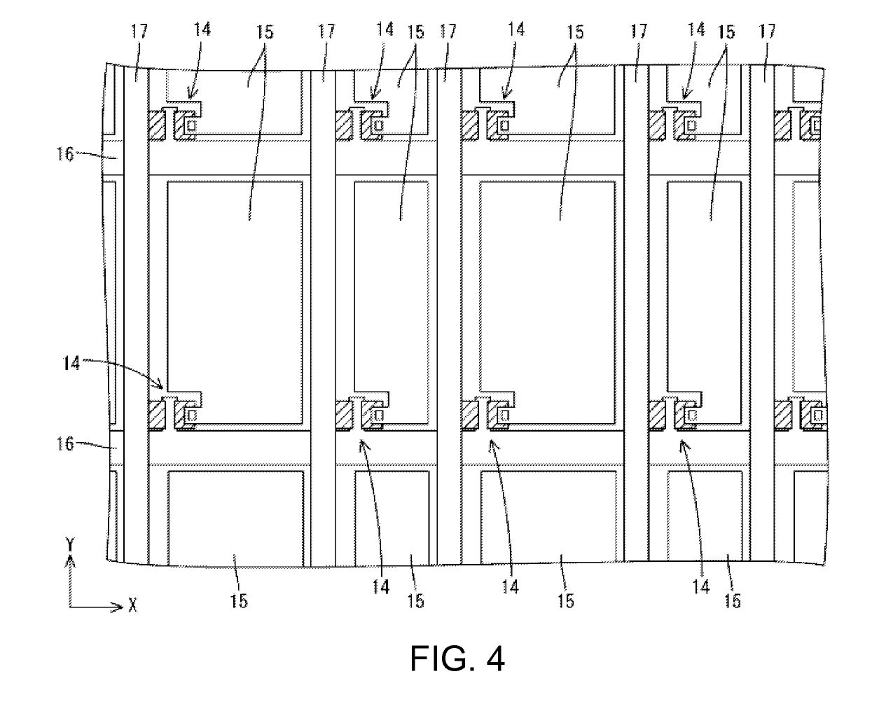

Of the two substrates 11a and 11b, one on the front side (front surface side) is a CF substrate 11a, and the other on the rear side (rear surface side) is an array substrate 11b. As shown in FIG. 4, on the inner surface of the array substrate 11b, or in other words, on a surface thereof on the side of the liquid crystal layer 11c (side facing the CF substrate 11a), a plurality of TFTs (thin film transistors) 14 that are switching elements and a plurality of pixel electrodes 15 are arranged in a matrix, and gate wiring lines 16 and source wiring lines 17 are disposed in a grid pattern so as to surround the respective TFTs 14 and pixel electrodes 15. Each pixel electrode 15 has a vertically long quadrangular (rectangular) shape with the long side direction matching the Y axis direction and the short side direction matching the X axis direction, and is made of a transparent electrode such as ITO (indium tin oxide) or ZnO (Zinc Oxide). The gate wiring lines 16 and the source wiring lines 17 are respectively connected to the gate electrodes and the source electrodes of the TFTs 14, and the pixel electrodes 15 are connected to the drain electrodes of the TFTs 14, respectively. As shown in FIG. 3, an alignment film 18 for defining the orientation of liquid crystal molecules is disposed on the TFTs 14 and the pixel electrodes 15 on the side facing the liquid crystal layer 11c. In an end portion of the array substrate 11b, terminals that are led out from the gate wiring lines 16 and the source wiring lines 17 are formed, and a not-shown driver part for driving liquid crystal is connected to these terminals through an anisotropic conductive film (ACF) by the pressure bonding. The driver part for driving liquid crystal is electrically connected to a not-shown display control circuit substrate through various wiring substrates and the like. The display control circuit substrate is connected to the image conversion circuit substrate VC in the television receiver TV (see FIG. 1), and supplies driving signals to the respective wiring lines 16 and 17 through a driver part in accordance with output signals from the image modification circuit substrate VC.

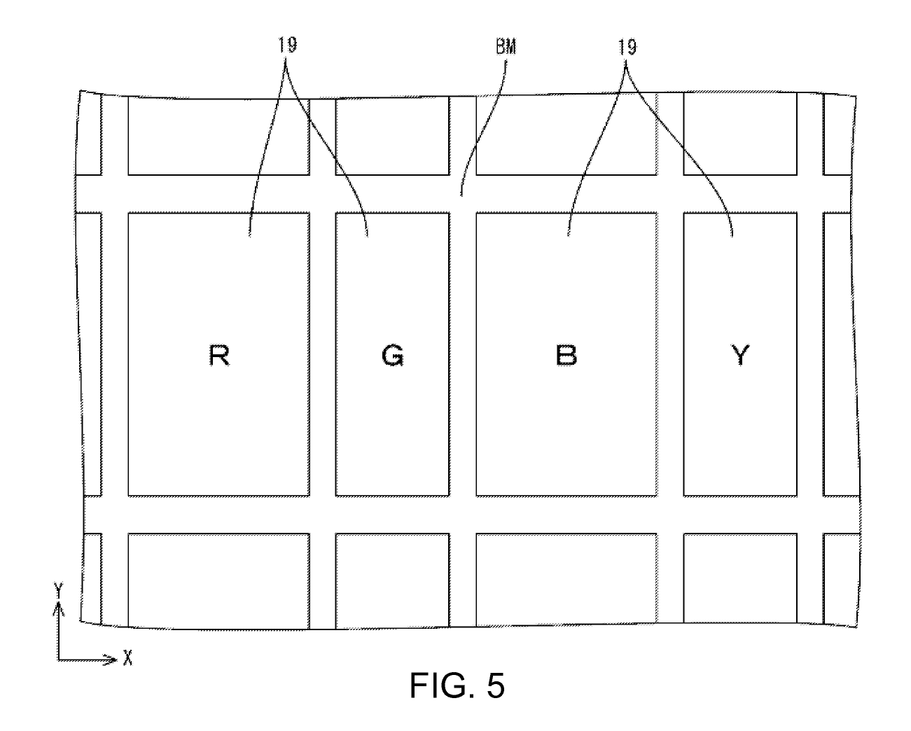

On the other hand, as shown in FIG. 5, on an inner surface of the CF substrate 11a, or in other words, on a surface thereof on the side of the liquid crystal layer 11c (side facing the array substrate 11b), color filters 19 made of a plurality of colored portions R, G, B, and Y arranged in a matrix so as to face the respective pixels on the array substrate 11b are formed. The color filters 19 of the present embodiment include yellow colored portions Y in addition to red colored portions R, green colored portions G, and blue colored portions B, which are the three primary colors of light, and the respective colored portions R, G, B, and Y selectively transmit light of the corresponding colors (corresponding wavelengths). Each of the colored portions R, G, B, and Y is formed in a vertically long quadrangular (rectangular) shape with the long side direction matching the Y axis direction and the short side direction matching the X axis direction, respectively, in a manner similar to the pixel electrodes 15. A grid-shaped light-shielding layer (black matrix) BM is disposed between the respective colored portions R, G, B, and Y to prevent the colors from being mixed. As shown in FIG. 3, in the CF substrate 11a, an opposite electrode 20 and an alignment film 21 are formed in this order on the surface of the color filters 19 facing the liquid crystal layer 11c.

The arrangement and size of the respective colored portions R, G, B, and Y constituting the color filters 19 will be explained in detail. As shown in FIG. 5, the respective colored portions R, G, B, and Y are arranged in a matrix with the X axis direction being the row direction and the Y axis direction being the column direction. The dimension of the respective colored portions R, G, B, and Y in the column direction (Y axis direction) is identical to each other, but the dimension thereof in the row direction (X axis direction) differs from each other among the respective colored portions R, G, B, and Y. Specifically, the respective colored portions R, G, B, and Y are arranged such that a red colored portion R, a green colored portion G, a blue colored portion B, and a yellow colored portion Y are aligned along the row direction in this order from the left side of FIG. 5, and the dimension of the red colored portion R and the blue colored portion B in the row direction is relatively large compared to the dimension of the yellow colored portion Y and the green colored portion G in the row direction. In other words, the colored portions R and B that have a relatively large dimension in the row direction, and the colored portions G and Y that have a relatively small dimension in the row direction are arranged alternately and repeatedly in the row direction. Accordingly, the area of the red colored portion R and the blue colored portion B is larger than the area of the green colored portion G and the yellow colored portion Y. The area of the blue colored portion B and the area of the red colored portion R are equal to each other. Similarly, the area of the green colored portion G and the area of the yellow colored portion Y are equal to each other. FIGS. 3 and 5 show a case in which the area of the red colored portion R and the blue colored portion B is approximately 1.6 times larger than the area of the yellow colored portion Y and the green colored portion G.

As a result of the color filters 19 having the above-mentioned configuration, in the array substrate 11b, as shown in FIG. 4, the dimension of the pixel electrodes 15 in the row direction (X axis direction) differs from each other among respective columns. In other words, among the respective pixel electrodes 15, the row direction dimension and area of pixel electrodes 15 that face the red colored portion R and the blue colored portion B become larger than the row direction dimension and area of pixel electrodes 15 that face the yellow colored portion Y and the green colored portion G. The gate wiring lines 16 are arranged at an equal pitch, while the source wiring lines 17 are arranged at two different pitches corresponding to the dimensions of the pixel electrodes 15 in the row direction.

As described above, because the liquid crystal display device 10 according to the present embodiment uses the liquid crystal panel 11 that has the color filters 19 made of four colored portions R, G, B, and Y, the television receiver TV is provided with a special image conversion circuit substrate VC as shown in FIG. 1. In other words, this image conversion circuit substrate VC can convert the television image signals outputted from the tuner T into image signals of respective colors of blue, green, red, and yellow, and can output the generated image signals of the respective colors to the display control circuit substrate. The display control circuit substrate drives TFTs 14 provided for pixels of respective colors in the liquid crystal panel 11 through the respective wiring lines 16 and 17, based on these image signals, thereby appropriately controlling the transmission of light that passes through the colored portions R, G, B, and Y of the respective colors.

(Backlight Device)

Next, a configuration of the backlight device 12 of the liquid crystal display device 10 will be explained. As shown in FIG. 2, the backlight device 12 includes a chassis 22 in a substantially box shape that has a light-exiting opening 22d on the side toward which light is emitted (liquid crystal panel 11 side), optical members 23 disposed to cover the light-exiting opening 22d of the chassis 22, and a frame 26 disposed along the outer edges of the chassis 22 and holding the optical members 23 by sandwiching outer edges thereof with the chassis 22. The chassis 22 includes LEDs 24 disposed immediately below the optical members 23 (liquid crystal panel 11) so as to face the optical members 23, LED substrates 25 on which the LEDs 24 are mounted, and diffusion lenses 27 attached to the LED substrates 25 in positions where the LEDs 24 are disposed. Accordingly, the backlight device 12 of the present embodiment is a so-called direct lighting type. The chassis 22 further includes holding members 28 that can hold the LED substrates 25 on the chassis 22, and a reflective sheet 29 that reflects light inside of the chassis 22 toward the optical members 23. Next, each component of the backlight device 12 will be described in detail below.

(Chassis)

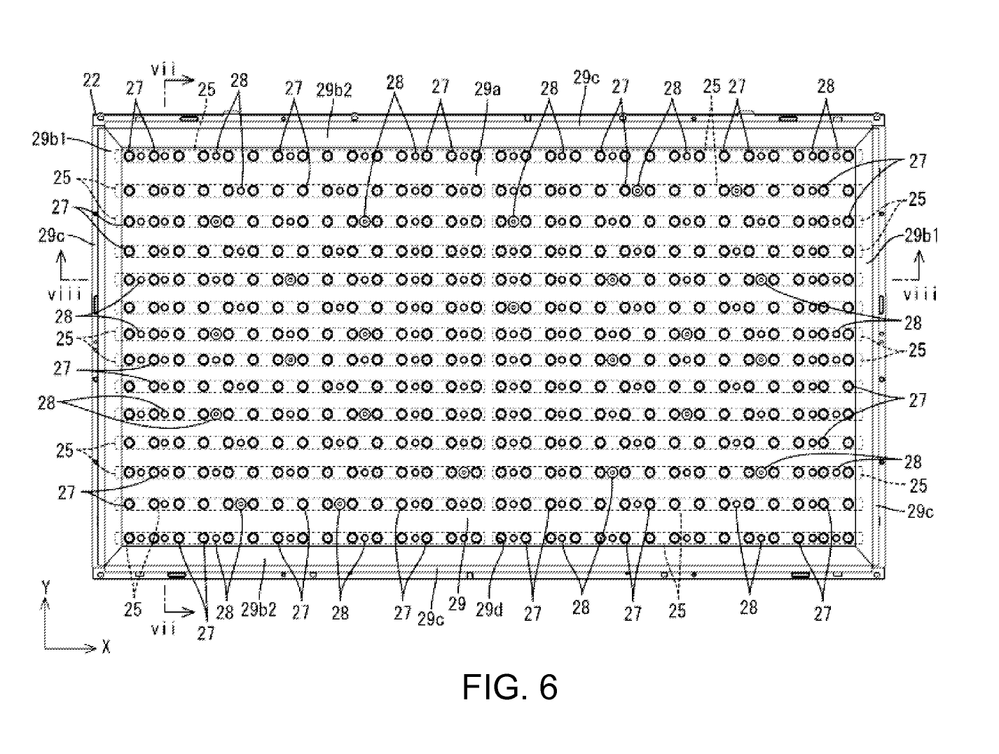

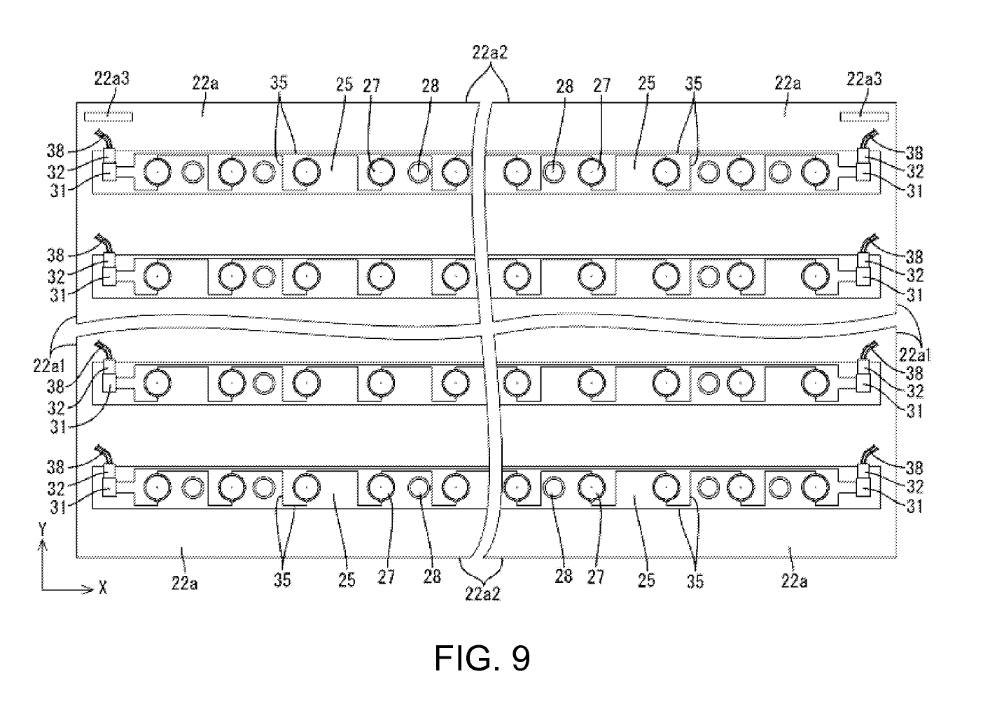

The chassis 22 is made of a metal, and as shown in FIGS. 6 to 8, includes a bottom plate 22a of a horizontally long quadrangular (rectangular) shape in a manner similar to the liquid crystal panel 11, and side plates 22b that rise from side edges on the respective sides (a pair of long sides and a pair of short sides) of the bottom plate 22a toward the front side (the side toward which light is emitted). The chassis 22 is formed in a substantially shallow box shape that opens toward the front side as a whole. The side edges of the bottom plate 22a of the chassis 22 include first side edges 22a1, which are side edges on the pair of short sides, and second side edges 22a2, which are side edges on the pair of long sides (see FIG. 9). In the chassis 22, the long side direction thereof matches the X axis direction (horizontal direction), and the short side direction thereof matches the Y axis direction (vertical direction). The frame 26 and the optical members 23, which will be described below, can be placed, from the front side, on respective supporting plates 22c of the chassis 22. The frame 26 is attached to the respective supporting plates 22c with screws. The bottom plate 22a of the chassis 22 has formed therein openings that are attachment holes 22d for attaching the holding members 28. A plurality of attachment holes 22d are dispersed throughout the bottom plate 22a in positions where the holding members 28 are to be attached.

(Optical Members)

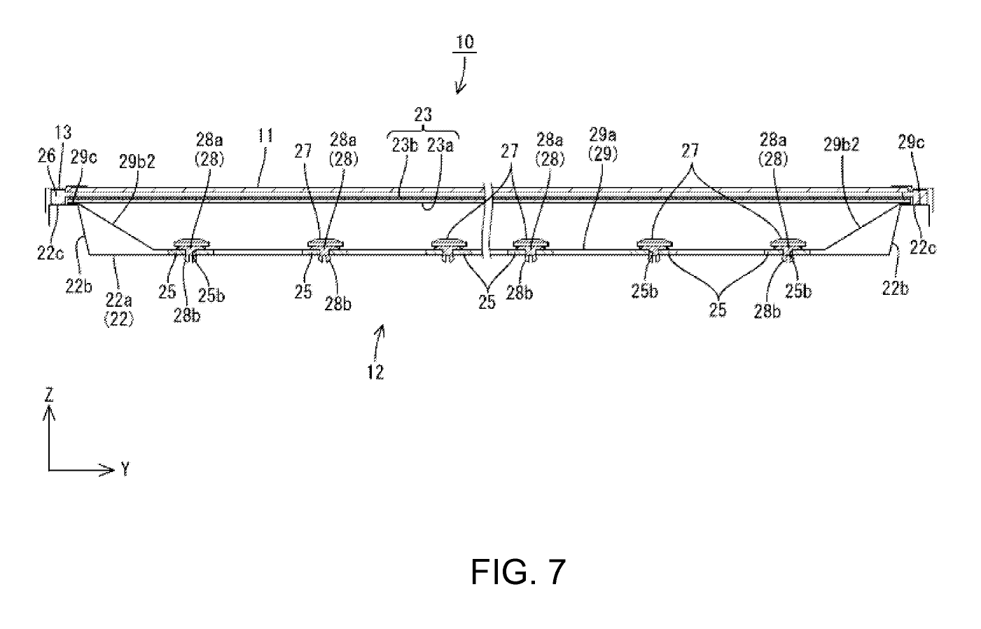

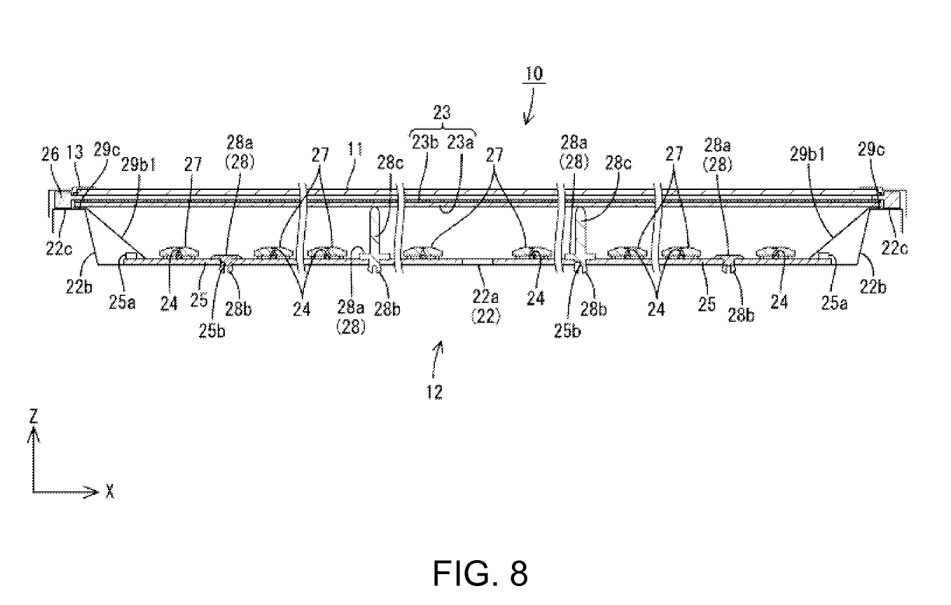

As shown in FIG. 2, the optical members 23 are in a horizontally long rectangular shape in a plan view, as in the liquid crystal panel 11 and the chassis 22. As shown in FIGS. 7 and 8, the outer edges of the optical members 23 are placed on the supporting plates 22c, thereby covering the light-exiting opening 22d of the chassis 22 and being interposed between the liquid crystal panel 11 and the LEDs 24 (LED substrates 25). The optical members 23 include a diffusion plate 23a disposed on the rear side (LEDs 24 side, opposite to the side toward which light is emitted), and optical sheets 23b disposed on the front side (liquid crystal panel 11 side, the side toward which light is emitted). The diffusion plate 23a has a configuration in which a plurality of diffusion particles are dispersed inside a plate-shaped base material made of an almost completely transparent resin having a prescribed thickness, and has the function of diffusing light that is transmitted through. The optical sheets 23b are thinner than the diffusion plate 23a, and two optical sheets 23b are layered, one on top of the other. Specific types of the optical sheets 23b include a diffusion sheet, a lens sheet, and a reflective polarizing sheet, for example, and it is possible to appropriately choose any of these sheets.

(Frame)

As shown in FIG. 2, the frame 26 is formed in a frame shape along the outer edges of the liquid crystal panel 11 and the optical members 23. The outer edges of the optical members 23 are sandwiched between the frame 26 and the respective supporting plates 22c (see FIGS. 7 and 8). The frame 26 receives the outer edges of the liquid crystal panel 11 from the rear side thereof, and sandwiches the outer edges of the liquid crystal panel 11 with the bezel 13 that is disposed on the front side (see FIGS. 7 and 8).

(LEDs)

As shown in FIG. 6, the LEDs 24 are mounted on the LED substrate 25, and are of a so-called top type LEDs in which light-emitting surfaces are on the side opposite to the mounting surface that is mounted on the LEDs 24. Each LED 24 includes an LED chip 24a that is a light-emitting source that emits blue light, and a green phosphor and a red phosphor as phosphors that emit light by being excited by the blue light. Specifically, each LED 24 has a configuration in which an LED chip 24a made of an InGaN type material, for example, is sealed by a resin material onto a base plate that is to be attached to the LED substrate 25. The LED chip 24a mounted on the base plate has a primary luminescence wavelength in a range of 420 nm to 500 nm, i.e., the blue wavelength region, and can emit highly pure blue light (blue single color light). The specific primary luminescence wavelength of the LED chip 24a is preferably 451 nm, for example. The resin material that seals in the LED chip 24a includes a green phosphor and a red phosphor mixed therein with a prescribed ratio. The green phosphor emits green light by being excited by the blue light emitted from the LED chip 24a, and the red phosphor emits red light by being excited by the blue light emitted from the LED chip 24a. By the blue light (blue component light) emitted from the LED chip 24a, the green light (green component light) emitted from the green phosphor, and the red light (red component light) emitted from the red phosphor, the LED 24 can emit light of a prescribed color as a whole such as white light or while light with a bluish tone, for example. Because yellow light can be obtained by mixing the green component light from the green phosphor and the red component light from the red phosphor, it can also be said that this LED 24 has both of the blue component light from the LED chip 24a and the yellow component light. The chromaticity of the LED 24 changes in accordance with the absolute values or the relative values of the contents of the green phosphor and the red phosphor, for example, and therefore, the chromaticity of the LED 24 can be adjusted by appropriately adjusting the contents of these green phosphor and red phosphor. In the present embodiment, the green phosphor has a primary luminescence peak in the green wavelength region from 500 nm to 570 nm inclusive, and the red phosphor has a primary luminescence peak in the red wavelength region from 600 nm to 780 nm inclusive.

Next, the green phosphor and the red phosphor included in the LED 24 will be explained in detail. It is preferable to use β-SiAlON that is a type of a SiAlON type phosphor as the green phosphor. The SiAlON type phosphor is a substance obtained by replacing a part of silicon atoms of silicon nitride with aluminum atoms, and by replacing a part of nitrogen atoms thereof with oxygen atoms, or in other words, the SiAlON is nitride. The SiAlON phosphor that is nitride has superior light-emitting efficiency and durability to those of other phosphors made of sulfide or oxide, for example. Here, “Having superior durability” specifically means that the brightness is less likely to deteriorate over time even after being exposed to high-energy exciting light from the LED chip, and the like. In the SiAlON phosphor, a rare earth element (such as Tb, Yg, or Ag) is used as an activator. β-SiAlON that is a type of the SiAlON type phosphor is a substance represented by a general formula Si6-ZAlZOZN:Eu (z represents the solid solubility) or (Si,Al)6(O,N)6:Eu in which aluminum and oxygen are dissolved in β-type silicon nitride crystal. In the β-SiAlON of the present embodiment, Eu (europium) is used as the activator, for example, and because the use of Eu contributes to high purity in the color green that is fluorescent light, it is very useful for adjusting the chromaticity of the LED 24. On the other hand, it is preferable to use CASN that is a type of CASN type phosphor. The CASN type phosphor is nitride that includes calcium atoms (Ca), aluminum atoms (Al), silicon atoms (Si), and nitrogen atoms (N), and has superior light-emitting efficiency and durability as compared with other phosphors made of fluoride or oxide, for example. In the CASN type phosphor, a rare earth element (such as Tb, Yg, or Ag) is used as an activator. CASN that is a type of the CASN type phosphor includes Eu (europium) as an activator, and is represented by a compositional formula of CaAlSiN3:Eu.

(LED Substrate)

As shown in FIG. 6, the LED substrate 25 has a base member that is in a horizontally long rectangular shape in a plan view, and is housed in the chassis 22 so as to extend along the bottom plate 22a with the long side direction thereof matching the X axis direction and the short side direction thereof matching the Y axis direction. Of plate surfaces of the base member of the LED substrate 25, a surface facing the front side (surface facing the optical members 23) has the LEDs 24 mounted thereon. The LEDs 24 are disposed such that the light-emitting surfaces face the optical members 23 (liquid crystal panel 11) and such that the optical axis thereof matches the Z axis direction, or in other words, the direction perpendicular to the display screen of the liquid crystal panel 11. A plurality of LEDs 24 are arranged in a row along the long side direction (X axis direction) of the LED substrate 25, and are connected to each other in series through a wiring pattern (an example of connecting wiring) 35 (see FIG. 9) formed on the LED substrate 25. The pitch at which the respective LEDs 24 are arranged is substantially constant, which means that the respective LEDs 24 are arranged at substantially even intervals.

As shown in FIG. 6, a plurality of LED substrates 25 having the above-mentioned configuration are aligned along the X axis direction and the Y axis direction, respectively, in the chassis 22 such that the respective long side directions are the same as each other and the respective short side directions are the same as each other. That is, the LED substrates 25 and the LEDs 24 mounted thereon are arranged in a matrix (matrix arrangement, two-dimensional arrangement) with the X axis direction (long side direction of the chassis 22 and the LED substrate 25) being the row direction, and the Y axis direction (short side direction of the chassis 22 and the LED substrate 25) being the column direction, respectively, in the chassis 22. Specifically, in the chassis 22, a total of 28 LED substrates 25 are disposed in an arrangement with two aligned in the X axis direction and fourteen aligned in the Y axis direction. Of two end portions of each LED substrate 25 along the long side direction, an end portion adjacent to the outer edge of the chassis 22 (end portion on the side opposite to an adjacent LED substrate 25 in the X axis direction) has a first connector part (an example of a first connecting member) 31 and a second connector part (an example of a second connecting member) 32 disposed therein. By the second connector part 32 being electrically connected to a connecting part of an external LED driver circuit through a power supply wiring line 38, power is supplied to each LED 24, and the driving of the LEDs 24 can be controlled. The pitch at which the respective LED substrates 25 are arranged along the Y axis direction is substantially even. Therefore, the respective LEDs 24 disposed two-dimensionally along the bottom plate 22a in the chassis 22 are arranged at substantially even intervals in the X axis direction and in the Y axis direction, respectively.

The base member of the LED substrate 25 is made of the same metal material as the chassis 22 such as an aluminum material, and on the surface thereof, the above-mentioned wiring pattern 35 is formed by using a metal film such as a copper foil through an insulating layer. On the outermost surface of the LED substrate 25, a reflective layer (not shown) of a highly reflective white is formed. The respective LEDs 24 disposed in a row on each LED substrate 25 are connected to each other in series by this wiring pattern 35. The base member of the LED substrate 25 may also be formed of an insulating material such as ceramics.

(Diffusion Lens)

The diffusion lenses 27 are made of a synthetic resin material (such as polycarbonate or acryl, for example) that is almost completely transparent (having a high light transmittance) and that has a refractive index higher than the air. As shown in FIGS. 6 to 8, the diffusion lenses 27 have a prescribed thickness and are each formed in a substantially circular shape in a plan view. Each of the diffusion lenses 27 is attached to the LED substrate 25 so as to cover the front side of an LED 24, or in other words, so as to be placed over an LED 24 in a plan view. The diffusion lens 27 transmits and diffuses light from the LED 24 that has great directivity. That is, the directivity of the light emitted from the LED 24 is lessened as the light passes through the diffusion lens 27, and therefore, even when a gap between adjacent LEDs 24 is made larger, an area therebetween becomes less likely to be recognized as a dark area. This makes it possible to reduce the number of LEDs 24 that need to be provided. The diffusion lenses 27 are positioned such that the respective centers thereof substantially match the centers of the respective LEDs 24 in a plan view. FIG. 7 shows a cross-sectional configuration of the holding members 28, and therefore, in terms of the diffusion lenses 27, the side faces of the diffusion lenses 27 that are positioned behind the holding members 28 on the page are shown.

(Holding Member)

The holding members 28 will be explained. The holding members 28 are made of a synthetic resin such as polycarbonate, and the surfaces thereof are a highly reflective white. As shown in FIGS. 6 to 8, the holding members 28 each have a main part 28a along the plate surface of the LED substrate 25 and a fixing part 28b that protrudes from the main part 28a toward the rear side, or in other words, toward the chassis 22 and that is attached to the chassis 22. The main parts 28a are formed in a substantially circular plate shape in a plan view, and can sandwich the LED substrate 25 with the bottom plate 22a of the chassis 22. The fixing parts 28b can be attached to the bottom plate 22a by being inserted through insertion holes 25b and attachment holes that are respectively formed in the LED substrate 25 and the bottom plate 22a of the chassis 22 in positions corresponding to where the respective holding members 28 are to be attached. As shown in FIG. 6, a plurality of holding members 28 are appropriately dispersed throughout the surface of the LED substrate 25b, and are adjacent to the respective diffusion lenses 27 (LEDs 24) with respect to the X axis direction.

As shown in FIGS. 6 to 8, the holding members 28 include two types of holding members: first holding members that hold the LED substrates 25 between the main parts 25a and the bottom plate 22a of the chassis 22 without having a bottom section 29a of the reflective sheet 29 therebetween; and second holding members that hold the LED substrates 25 and the bottom section 29a of the reflective sheet 29 between the main parts 25a and the bottom plate 22a of the chassis 22. Among them, the holding members 28 that hold the LED substrates 25 and the bottom section 29a of the reflective sheet 29 (second holding members) include two types: holding members provided with supporting parts 28c that protrude from the main parts 28a toward the front side; and holding members that do not have the supporting parts 28c. The supporting parts 28c can support the optical members 23 (diffusion plate 23a directly) from the rear side thereof, thereby maintaining the positional relationship between the LEDs 24 and the optical members 23 in the Z axis direction and preventing the optical members 23 from being deformed inadvertently.

(Reflective Sheet)

The reflective sheet 29 is made of a synthetic resin, and the surface thereof is a highly reflective white. As shown in FIGS. 6 to 8, the reflective sheet 29 is large enough to be laid over the almost entire inner surface of the chassis 22, and therefore, it is possible to cover all of the LED substrates 25 arranged in rows in the chassis 22 from the front side thereof. With the reflective sheet 29, light inside of the chassis 22 can be efficiently directed toward the optical members 23. The reflective sheet 29 has: the bottom section 29a disposed along the bottom plate 22a of the chassis 22 and having a size that can cover the large part of the bottom plate 22a; first inclined sections 29b1 that rise from the outer edges on the short sides of the bottom section 29a toward the front side while being inclined toward the bottom section 29a; second inclined sections 29b2 that rise from the outer edges on the long sides of the bottom section 29a toward the front side while being inclined toward the bottom section 29a; and extension sections 29c that extend respectively from the outer edges of the inclined sections 29b1 and 29b2 toward the outside and that are placed on the supporting plates 22c of the chassis 22. The reflective sheet 29 is disposed such that the bottom section 29a thereof faces the front side surfaces of the respective LED substrates 25, or in other words, the mounting surfaces of the LEDs 24. The bottom section 29a of the reflective sheet 29 has openings that are lens insertion holes 29d through which the respective diffusion lenses 27 are inserted in positions corresponding to the respective diffusion lenses 27 (respective LEDs 24) in a plan view.

The bottom section 29a also has openings that are holding member insertion holes through which the fixing parts 28b are inserted in positions corresponding to the respective holding members 28 in a plan view, and the holding member insertion holes for the holding members 28 that hold the LED substrates 25 without having the bottom section 29a therebetween (first holding members), in particular, are formed to be large enough to allow the main parts 28a thereof to also pass through. In this way, the LED substrates 25 placed in the chassis 22 can be affixed to the bottom plate 22a of the chassis 22 by the holding members 28 (first holding members), and when placing the reflective sheet 29 inside of the chassis 22 thereafter, it is possible to prevent the bottom section 29a from riding on the main parts 28a of these holding members 28 (first holding members). The bottom section 29a is affixed to the chassis 22 together with the LED substrates 25 by the holding members 28 (second holding members) that are attached after the reflective sheet 29 is placed inside the chassis 22, thereby preventing the reflective sheet 29 from being raised or warped.

(Purposes of Having Four Primary Colors in Liquid Crystal Panel and Differentiating Areas of Respective Colored Portions of Color Filters)

As already discussed above, the color filters 19 of the liquid crystal panel 11 of the present embodiment have the yellow colored portions Y, in addition to the respective colored portions R, G, and B, which are the three primary colors of light, as shown in FIGS. 3 and 5. Therefore, the color gamut of the display image displayed by the transmitted light is increased, thereby making it possible to realize the display with excellent color reproducibility. In addition, because the light that has transmitted through the yellow colored portions Y has a wavelength that is close to the luminosity peak, it tends to be perceived by human eyes as bright light even with small amount of energy. As a result, even if the power output of the LEDs 24 in the backlight device 12 is reduced, the sufficient brightness can be obtained, thereby achieving the effects such as a reduction in power consumption of the LEDs 24 and thus excellent environmental performance.

On the other hand, when using the liquid crystal panel 11 having four primary colors as described above, the display image on the liquid crystal panel 11 tends to have a yellowish tone as a whole. In order to avoid this, in the backlight device 12 of the present embodiment, the chromaticity of the LEDs 24 is adjusted to have a bluish tone, which is a complementary color of yellow, such that the chromaticity of the display image is corrected. For this reason, the LEDs 24 provided in the backlight device 12 have the primary luminescence wavelength in the blue wavelength region as mentioned above, and emit light in the blue wavelength region at the highest intensity.

The research conducted by the inventor of the present invention shows that, when adjusting the chromaticity of the LEDs 24 as described above, as the chromaticity is made closer from white to blue, the brightness of the emitted light tends to be lowered. Thus, in the present embodiment, the area of the blue colored portions B in the color filters 19 is made larger than the area of the green colored portions G and the yellow colored portions Y, which makes it possible to include more blue light, which is the complementary color of yellow, in the transmitted light of the color filters 19. This way, when adjusting the chromaticity of the LEDs 24 to correct the chromaticity of the display image, it is not necessary to adjust the chromaticity of the LEDs 24 toward the blue color as much as before, and as a result, it is possible to prevent the brightness of the LEDs 24 from lowering due to the chromaticity adjustment.

Furthermore, according to the research conducted by the inventor of the present invention, when using the liquid crystal panel 11 having four primary colors, the brightness of the red color is lowered in particular among the light emitted from the liquid crystal panel 11. The possible cause thereof is that, in the liquid crystal panel 11 having four primary colors, the number of subpixels constituting one pixel increases from three to four, thus reducing the area of each subpixel compared to a liquid crystal panel having three primary colors, and as a result, the brightness of the red color in particular is lowered. To avoid this situation, in the present embodiment, the area of the red colored portions R in the color filters 19 is made larger than the area of the green colored portions G and the yellow colored portions Y, which makes it possible to include more red color in the transmitted light of the color filters 19. As a result, it is possible to prevent the brightness of the red light from lowering due to having four colors in the color filters 19.

(Description of Configuration of Main Part of the Present Embodiment)

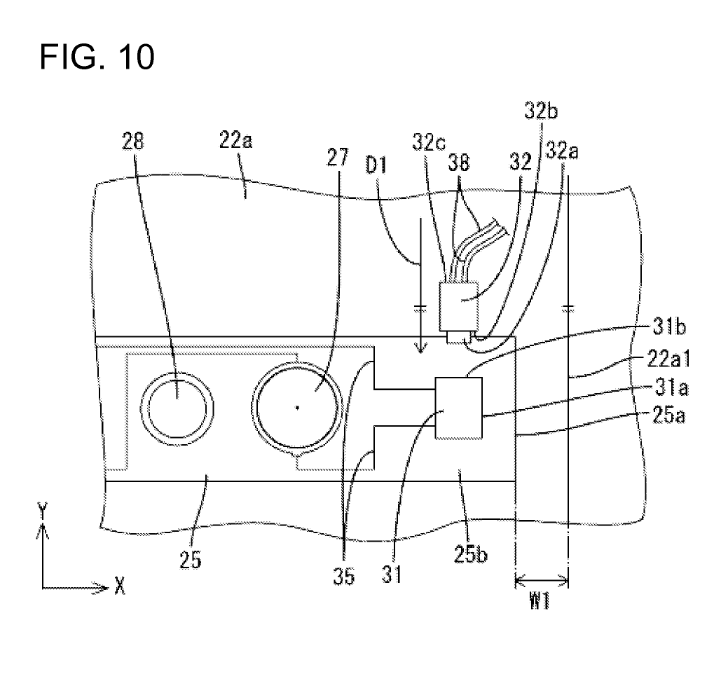

Next, configurations and connecting structures of the wiring patterns 35 formed on the LED substrates 25 and the first connector parts 31, and configurations and connecting structures of the second connector parts 32 and the power supply wiring lines 38, which are main parts of the present embodiment, will be explained in detail. First, the configurations and connecting structures of the wiring patterns 35 formed on the LED substrates 25 and the first connector parts 31 will be explained. As shown in FIG. 9, the wiring pattern 35 connects the respective LEDs 24 to each other in series by extending on the LED substrate 25 in a zigzag manner. The first connector parts 31 are each formed in a rectangular shape in a plan view, and are disposed such that the respective plane directions of side faces match the X axis direction and the Y axis direction, respectively. In each of the LED substrates 25, the first connector part 31 is disposed on an end portion 25b that has, of two end faces on the short sides of the LED substrate 25 (two end faces along the longitudinal direction), one end face 25a of the LED substrate 25 that faces either of the two side plates 22b that rise from the first side edges 22a1 of the bottom plate 22a (outer side of the chassis 22) (see FIG. 10). The respective ends of the wiring pattern 35 are electrically connected to the first connector part 31 on the end portion 25b.

Next, the configurations and the connecting structure of the second connector parts 32 and the power supply wiring lines 38 will be explained. As shown in FIGS. 9 and 10, the second connector parts 32 are each formed in a rectangular shape in a plan view, and are disposed such that the respective plane directions of side faces match the X axis direction and the Y axis direction, respectively, in a manner similar to the first connector parts 31. As shown in FIG. 9, the respective second connector parts 32 are connected to the first connector parts 31 in the same direction as each other. Specifically, as shown in FIG. 10, each second connector part 32 is electrically connected to a first connector part 31 in a connecting direction D1 that is a direction along the plane of the bottom plate 22a (direction along the plane of the LED substrate 25) and that is, in a plan view, a direction directed from one of the second side edges 22a2 of the bottom plate 22a toward the other second side edge 22a2 (direction from the upper side toward the lower side of FIGS. 9 and 10) in parallel with the first side edges 22a1 of the bottom plate 22a of the chassis 22. The second connector part 32 has a connector plug 32a on a side face 32b that is connected to the first connector part 31. The connector plug 32a protrudes toward the first connector part 31 and can be plugged into the first connector part 31. By the connector plug 32a being plugged into the first connector part 31 along the above-mentioned connecting direction, the second connector part 32 is connected and affixed to the first connector part 31.

The power supply wiring lines 38 are electrically connected to the second connector part 32, and as shown in FIG. 10, extend from a side face 32c of the second connector part 32 on the side opposite to the side face 32b that is connected to the first connector part 31. The power supply wiring lines 38 that extend from the side faces 32b of the respective second connector parts 32 are led out to respective wiring insertion openings 22a3 disposed near one of the second side edges 22a2 of the bottom plate 22a in the chassis 22 (see FIG. 9). The power supply wiring lines 38 led out to the wiring insertion openings 22a3 are inserted through the wiring insertion openings 22a3 and are led out to the rear side of the chassis 22, and on the rear side of the chassis 22, the power supply wiring lines 38 are electrically connected to connector parts of the LED driver circuit. Therefore, when the first connector parts 31 and the second connector parts 32 are connected to each other, the power supply wiring lines 38 and the wiring patterns 35 are electrically connected to each other via the first connector parts 31 and the second connector parts 32, thereby allowing power to be supplied from the LED driver circuit to the respective LEDs 24. FIGS. 9 and 10 only show portions of the power supply wiring lines 38 connected to the second connector parts 32, and other portions are not shown in the figures.

Because the second connector parts 32 are connected to the first connector parts 31, respectively, with the direction D1 being the connecting direction, each second connector part 32 is disposed on the side face 31b that is adjacent to one of the long side edges of the LED substrate 25, out of side faces of the first connector part 31, and is not disposed on the side face 31a that faces the side plate 22b on the short side of the chassis 22 (the side face 31a that faces the first side edge 22a1). In this configuration, because the second connector part 32 is not disposed between the first side edge 22a1 and the one end face 25a of the LED substrate 25, it is possible to move the first side edge 22a1 closer to the one end face 25a of the LED substrate 25, which allows the distance W1 between the first side edge 22a1 and the one end face 25a of the LED substrate 25 to be smaller. Thus, in the backlight device 12, the distance W1 between each first side edge 22a1 of the bottom plate 22a (each side plate 22b on the short side of the chassis 22) and the one end faces 25a of the respective LED substrates 25 is made smaller compared to the configuration in which each second connector part 32 is disposed on the side face 31a that faces the first side edge 22a1, out of the side faces of the first connector part 31 (see FIG. 10). This allows the frame region of the backlight device 12 to be narrower.

Because the second connector parts 32 are connected to the first connector parts 31, respectively, with the direction D1 being the connecting direction, the power supply wiring lines 38 connected to the respective second connector parts 32 also extend toward one of the long side edges of the respective LED substrates 25. As a result, in the backlight device 12, the power supply wiring lines 38 are less likely to be disposed between the first side edges (side plates 22b on the short sides of the chassis 22) 22a1 of the bottom plate 22a and the one end faces 25a of the respective LED substrates 25, and therefore, it is possible to reduce the distance W1 between each first side edge (each side plate 22b on the short side of the chassis 22) 22a1 of the bottom plate 22a and the one end faces 25a of the LED substrates 25.

As described above, in the backlight device 12 of the present embodiment, by connecting the first connector part 31 and the second connector part 32 with the direction D1 being the connecting direction, it is possible to achieve a configuration in which the second connector parts 32 are less likely to be disposed between the side plates 22b of the chassis 22 and the one end faces 25a of the respective LED substrates 25 compared to the configuration in which the connecting direction is a direction directed from the first side edge 22a1 facing the one end face 25a of the LED substrate 25 toward the one end face 25a at a right angle with respect to the first side edge 22a1 (compared to the configuration in which the second connector part 32 is disposed on the side face of the first connector part 31 that faces the first side edge 22a1). Thus, the second connector parts 32 do not make it difficult for the side plates 22b of the chassis 22 to be made closer to the one end faces 25a of the respective LED substrates 25 (inner side of the chassis 22), and therefore, it is possible to narrow the distance between the side 22b plates of the chassis 22 and the one end faces 25a of the respective LED substrates 25. As a result, it is possible to achieve a narrower frame region in the direct lighting type backlight device 12 in which the power supply wiring lines 38 are connected at the end portions 25b of the LED substrates 25.

In the backlight device 12 of the present embodiment, the bottom plate 22a of the chassis 22 is formed in a horizontally long rectangular shape, and the side edges 22a1 and 22a2 include a pair of first side edges 22a1 along the short side direction (Y axis direction) of the bottom plate 22a and a pair of second side edges 22a2 along the long side direction (X axis direction) of the bottom plate 22a1. A plurality of LED substrates 25 are disposed on the bottom plate 22a, and respective one end faces 25a face the side plates 22b that rise from the first side edges 22a1, respectively. Furthermore, the first connector parts 31 are disposed on the plurality of LED substrates 25, respectively, and the second connector parts 32 are connected to the plurality of first connector parts 31. In the backlight device 12 in which a plurality of LED substrates 25 are disposed on the bottom plate 22a, the distance between the side plates 22b that rise from the first side edges 22a1 and the respective one end faces 25a of the LED substrates 25 can be made smaller, thereby making it possible to achieve a narrower frame region in the backlight device 12.

In the backlight device 12 of the present embodiment, the respective plurality of second connector parts 32 are connected to the first connector parts 31 in the same connecting direction as each other. Therefore, when connecting the first connector parts 31 and the second connector parts 32 to each other in the manufacturing process of the backlight device 12, the connecting work can be conducted in the same direction for all of the connectors.

The backlight device 12 of the present embodiment further includes the diffusion lenses 27 that are respectively disposed on the respective plurality of LED substrates 25 to cover the light-emitting sides of the LEDs 24 and to diffuse light from the LEDs 24. Thus, as a result of the light from the LEDs 24 passing through the diffusion lenses 27, the light from the LEDs 24 is diffused and the directivity thereof is lessened, and therefore, even when the number of LEDs 24 is reduced, it is possible to maintain a prescribed brightness in the backlight device 12.

The backlight device 12 of the present embodiment further includes the reflective sheet 29 that has the bottom section 29a laid over the LED substrates 25, the lens insertion holes 29d disposed in the bottom section 29a for having the diffusion lenses 27 inserted therethrough, and the respective inclined sections 29b1 and 29b2 that rise toward the light-exiting opening 22d (front side) of the chassis 22 near the side plates 22b of the chassis 22. Among the plurality of second connector parts 32, second connector parts 32 that are closest to the respective second side edges 22a2 are disposed between the reflective sheet 29 and the side plates 22b that rise from the respective first side edges 22a1. This way, the light emitted from the LEDs 24 and travelling toward the inclined sections 22b1 and 22b2 of the reflective sheet 29 is not blocked by the first connector parts 31 or the second connector parts 32, thereby increasing the utilization efficiency of light that was emitted from the LEDs 24.

### Embodiment 2

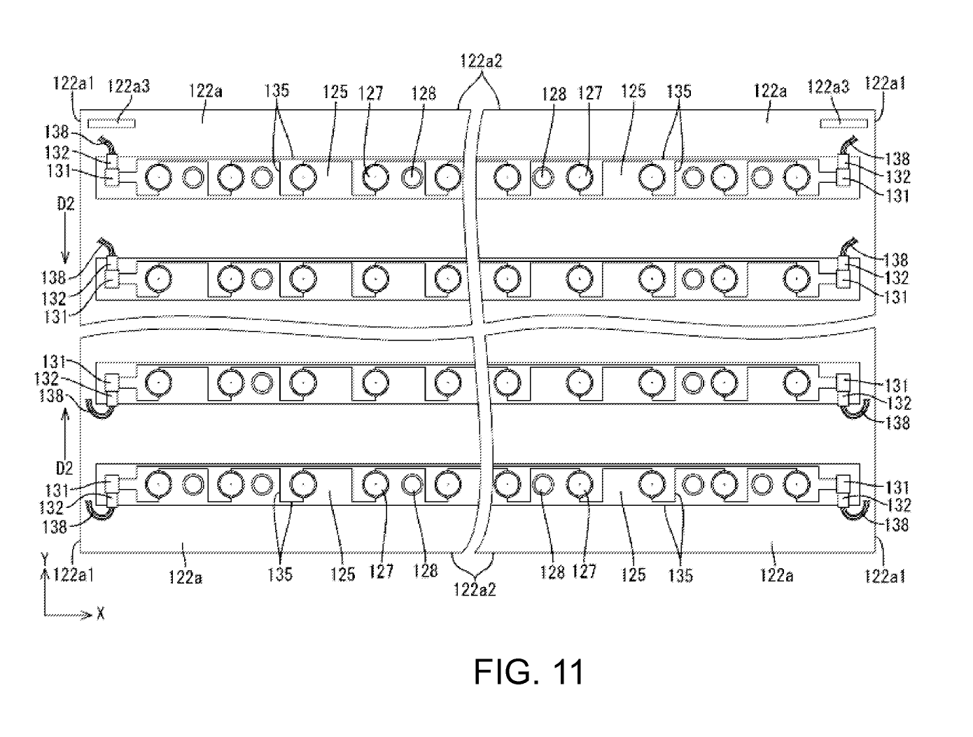

Embodiment 2 will be described with reference to the drawings. Embodiment 2 differs from Embodiment 1 in the connecting direction in which second connector parts 132 are connected to first connector parts 131, respectively. Other configurations are similar to those of Embodiment 1, and therefore, descriptions of the configurations, the operation, and the effect will be omitted. Parts in FIG. 11 that have 100 added to the reference characters of FIG. 9 are the same as these parts described in Embodiment 1.

As shown in FIG. 11, in the backlight device of Embodiment 2, the respective second connector parts 132 are connected to the respective first connector parts 131 in directions D2 that are directions parallel to first side edges 122a1 of a bottom plate 122a of a chassis 122 in a plan view and that are directions from respective second side edges 122a2 toward the center of the bottom plate 122a of the short side direction. With this configuration, in the backlight device of Embodiment 2, when connecting the respective second connector parts 132 to the respective first connector parts 131 in the manufacturing process of the backlight device, it is possible to connect the second connector parts 132 in the directions from the respective long sides of the chassis 122. That is, it is possible to conduct connecting work for the second connector parts 132 from two sides, which are the two long sides of the chassis 122.

### Embodiment 3

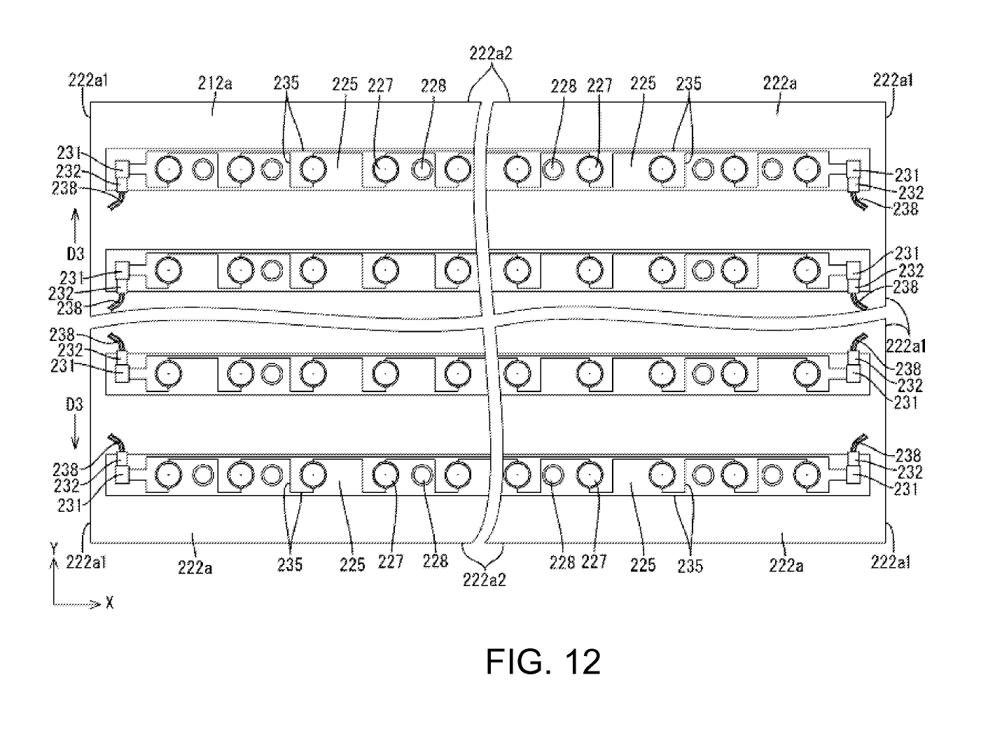

Embodiment 3 will be described with reference to the drawings. Embodiment 3 differs from Embodiment 1 in the connecting direction in which second connector parts 232 are connected to first connector parts 231, respectively. Other configurations are similar to those of Embodiment 1, and therefore, descriptions of the configurations, the operation, and the effect will be omitted. Parts in FIG. 12 that have 200 added to the reference characters of FIG. 9 are the same as these parts described in Embodiment 1.

As shown in FIG. 12, in the backlight device of Embodiment 3, the respective second connector parts 232 are connected to the respective first connector parts 231 in directions D3 that are directions parallel to first side edges 222a1 of a bottom plate 222a of a chassis 222 in a plan view and that are directions from the center of the bottom plate 222a of the short side direction toward respective second side edges 222a2. Wiring insertion openings are disposed near the center portion of the bottom plate 222a in the short side direction (and therefore, FIG. 12 does not show the wiring insertion openings). In the backlight device of Embodiment 3, by connecting the respective second connector parts 232 to the respective first connector parts 231 in the above-mentioned connecting directions, respective power supply wiring lines 238 connected to the respective second connector parts 232 extend toward the center of the bottom plate 222a in the short side direction. This makes it possible to draw the power supply wiring lines 238 toward the center of the bottom plate 222a in the short side direction with ease, thereby allowing the power supply wiring lines 238 to be inserted through the wiring insertion openings formed near the center portion of the bottom plate 222a.

Also, in the backlight device of Embodiment 3, by connecting the respective second connector parts 232 to the respective first connector parts 231 in the above-mentioned connecting directions, each second connector part 232 is disposed on a side face of a first connector part 231 that is oriented toward the center of the bottom plate 222 in the short side direction as shown in FIG. 12. This way, the respective second connector parts 232 positioned closest to the pair of second side edges 222a2 are not disposed between the respective LED substrates 225 positioned closest to the pair of second side edges 222a2 and the side plates that rise from the respective second side edges 222a2. This makes it possible to respectively move the pair of second side edges 222a2 closer to the LED substrates 225 (inner side; toward the center of the bottom plate 222a in the short side direction), and therefore, the distance between the LED substrates 225 and the side plates that rise from the second side edges 222a2 can be reduced. As a result, it is possible to achieve an even narrower frame region in the backlight device.

### Embodiment 4

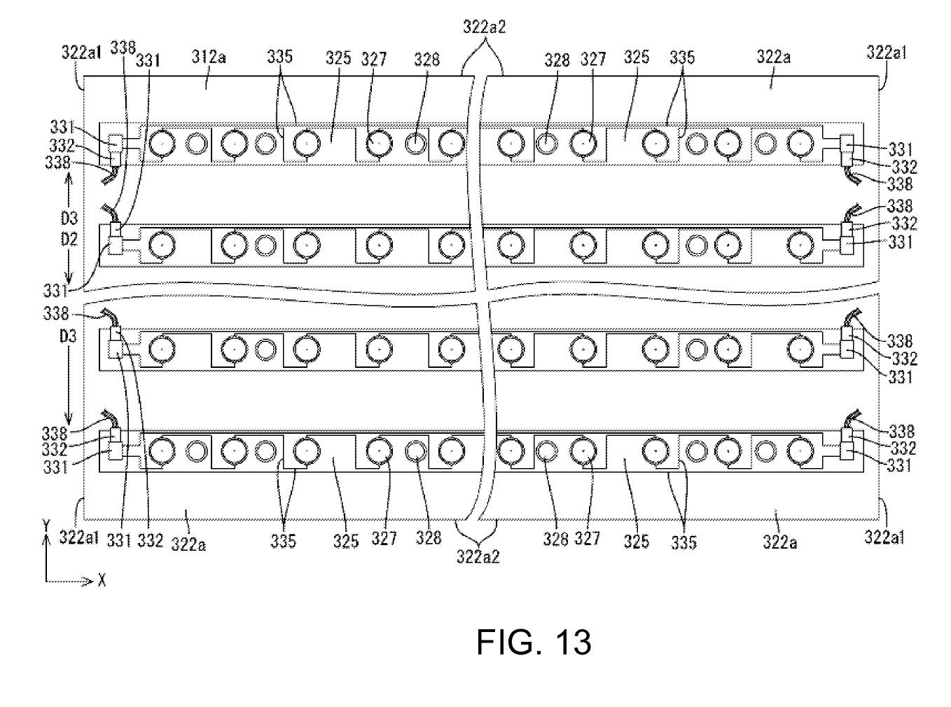

Embodiment 4 will be described with reference to the drawings. Embodiment 4 differs from Embodiment 1 in the connecting direction in which second connector parts 332 are connected to first connector parts 331, respectively. Other configurations are similar to those of Embodiment 1, and therefore, descriptions of the configurations, the operation, and the effect will be omitted. Parts in FIG. 13 that have 300 added to the reference characters of FIG. 9 are the same as these parts described in Embodiment 1.

As shown in FIG. 13, in the backlight device of Embodiment 4, the connecting direction in which the respective second connector parts 332 are connected to the respective first connector parts 331 is a direction that is parallel to first side edges 322a1 of a bottom plate 322a of a chassis 322 in a plan view. Second connector parts 332 positioned closest to one second side edge (the second side edge on the upper side of FIG. 13) 322a2 of the pair of second side edges 322a2 are connected to the respective first connector parts 331 in a direction D3 from the center of the bottom plate 322 in the short side direction toward the second side edge 322a2. On the other hand, the other second connector parts 332 are connected to the respective first connector parts 331 in a direction D2 from the second side edge 322a2 toward the center of the bottom plate 322 in the short side direction.

As described above, in the backlight device of Embodiment 4, the respective second connector parts 332 are connected to the respective first connector parts 331 in the above-mentioned direction D2, and therefore, the respective second connector parts 332 positioned closest to the pair of second side edges 322a2 are not disposed between the respective LED substrates 325 positioned closest to the pair of second side edges 322a2 and the side plates that rise from the second side edges 322a2. This makes it possible to respectively move the pair of second side edges 322a2 closer to the LED substrates 325 (inner side; toward the center of the bottom plate 222 in the short side direction), and therefore, the distance between the LED substrates 325 and the side plates that rise from the second side edges 322a2 can be reduced. Also, the connecting direction in which the second connector parts 332 are connected to the first connector parts 331 is the same among all of the second connector parts 332, except for the second connector parts 332 positioned closest to the one second side edge (second side edge on the upper side in FIG. 13) 322a2, and therefore, in the manufacturing process of the backlight device, the process to connect the second connector parts 332 to the first connector parts 331 can be made easier.

### Embodiment 5

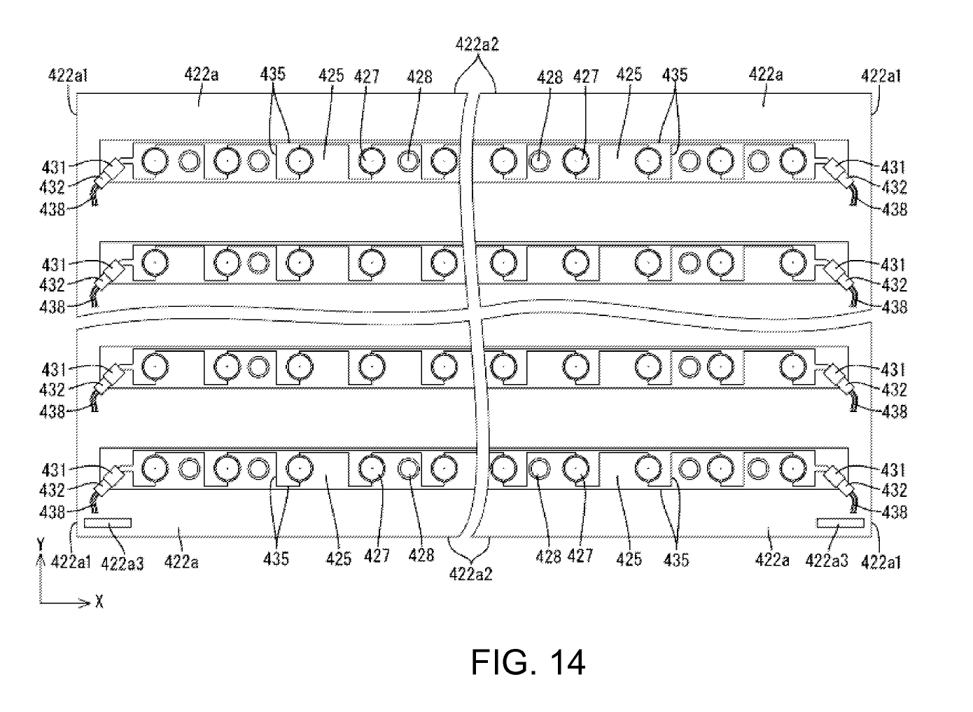

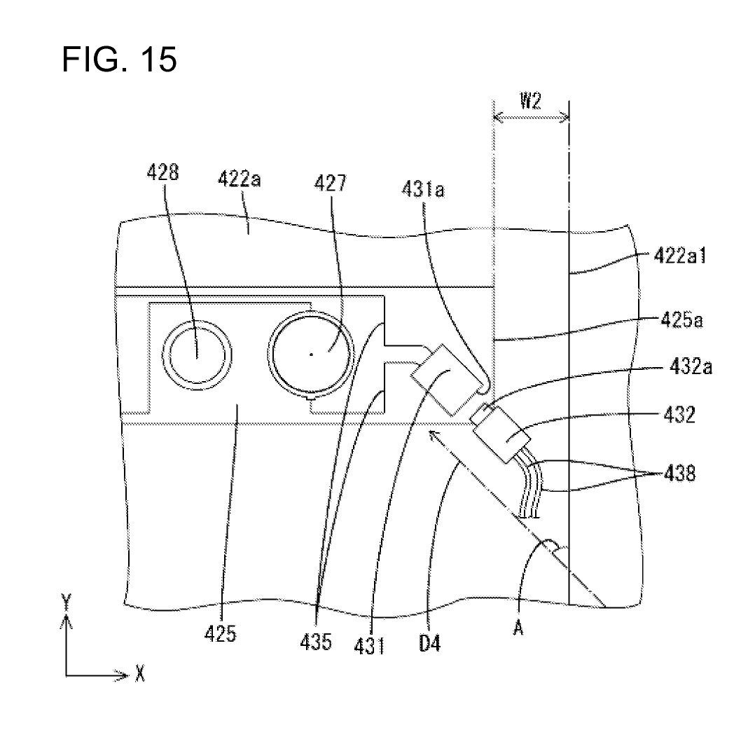

Embodiment 5 will be described with reference to the drawings. Embodiment 5 differs from Embodiment 1 in the arrangement of first connector parts 431 and the connecting direction in which second connector parts 432 are connected to the first connector parts 431. Other configurations are similar to those of Embodiment 1, and therefore, descriptions of the configurations, the operation, and the effect will be omitted. Parts in FIG. 14 that have 400 added to the reference characters of FIG. 9 are the same as these parts described in Embodiment 1. Parts in FIG. 15 that have 400 added to the reference characters of FIG. 10 are the same as these parts described in Embodiment 1.

As shown in FIGS. 14 and 15, in the backlight device of Embodiment 5, the first connector parts 431 are disposed such that the directions of the planes of side faces of each first connector part 431 having a rectangular shape in a plan view do not match the X axis direction or the Y axis direction. Specifically, in a plan view, the first connector parts 431 are disposed such that a side face 431a of each first connector part 431 to which the second connector part 432 is connected is oriented diagonally. Each second connector part 432 is electrically connected to the first connector part 31 in a direction D4. The direction D4 is a direction that is parallel to the plane of the bottom plate 422a (parallel to the plane of the LED substrates 425) and that is directed from a first side edge 422a1 facing one end face 425a of the LED substrate 425 toward an end portion 425b thereof that has the one end face 425a at an acute angle with respect to the first side edge 422a1 in a plan view. The acute angle A is set to 45° in the present embodiment.

As described above, in the backlight device of Embodiment 5, by the second connector parts 432 being connected to the first connector parts 431, respectively, in the above-mentioned connecting direction, only a portion of each second connector part 432 is disposed between the first side edge 422a1 and the one end face 425a of the LED substrate 425 as shown in FIG. 15. On the other hand, if the connecting direction were a direction directed from the first side edge 422a1 that faces the one end face 425a of the LED substrate 425 toward the one end face 425a at a right angle with respect to the first side edge 422a1, the entire second connector part 432 would be disposed between the first side edge 422a1 and the one end face 425a of the LED substrate 425. Thus, in the backlight device of the present embodiment, a distance W2 between the first side edge 422a1 of the bottom plate 422a (side plate on the short side of the chassis 422) and the one end face 425a of the LED substrate 425 is made narrower (see FIG. 15) than the configuration in which the connecting direction is a direction directed from the first side edge 422a1 that faces the one end face 425a of the LED substrate 425 toward the one end face 425a at a right angle with respect to the first side edge 422a1. As a result, in the backlight device of the present embodiment, the frame region is made narrower.

If the above-mentioned acute angle A were smaller than 30° or greater than 60°, it would become difficult to connect the second connector parts 432 to the first connector parts 431. In the backlight device of the present embodiment, the above-mentioned acute angle A is 45°, and the range thereof is set to 30° to 60°, and therefore, it is easy to connect the second connector parts 432 to the first connector parts 431.

Also, in the backlight device of Embodiment 5, the respective plurality of second connector parts 432 are connected to the first connector parts 431 in the same direction for all of the connectors. Therefore, when connecting the first connector parts 431 to the second connector parts 432 in the manufacturing process of the backlight device, the connecting work can be conducted in the same direction for all of the connectors.

### Embodiment 6

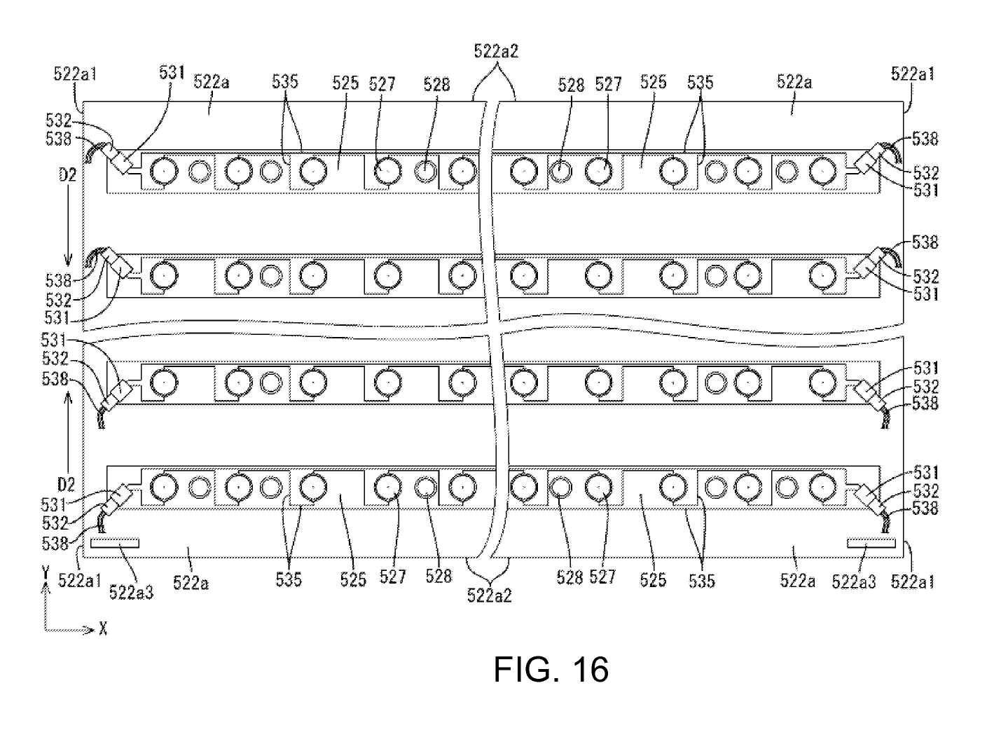

Embodiment 6 will be described with reference to the drawings. Embodiment 6 differs from Embodiment 5 in the connecting direction in which second connector parts 532 are connected to first connector parts 531. Other configurations are similar to those of Embodiment 5, and therefore, descriptions of the configurations, the operation, and the effect will be omitted. Parts in FIG. 16 that have 100 added to the reference characters of FIG. 14 are the same as these parts described in Embodiment 5.

In the backlight device of Embodiment 6, as shown in FIG. 16, the respective second connector parts 532 are connected to the respective first connector parts 531 in directions D2 and that are respectively directed from second side edges 522a2 toward the center of a bottom plate 522a of a chassis 522 in the short side direction in parallel with first side edges 522a1 of the bottom plate 522a in a plan view. With this configuration, in the backlight device of Embodiment 6, in the manufacturing process of the backlight device, the second connector parts 532 can be connected to the respective first connector parts 531 from the respective long sides of the chassis 522. That is, it is possible to conduct connecting work for the second connector parts 532 from two sides, which are the two long sides of the chassis 522.

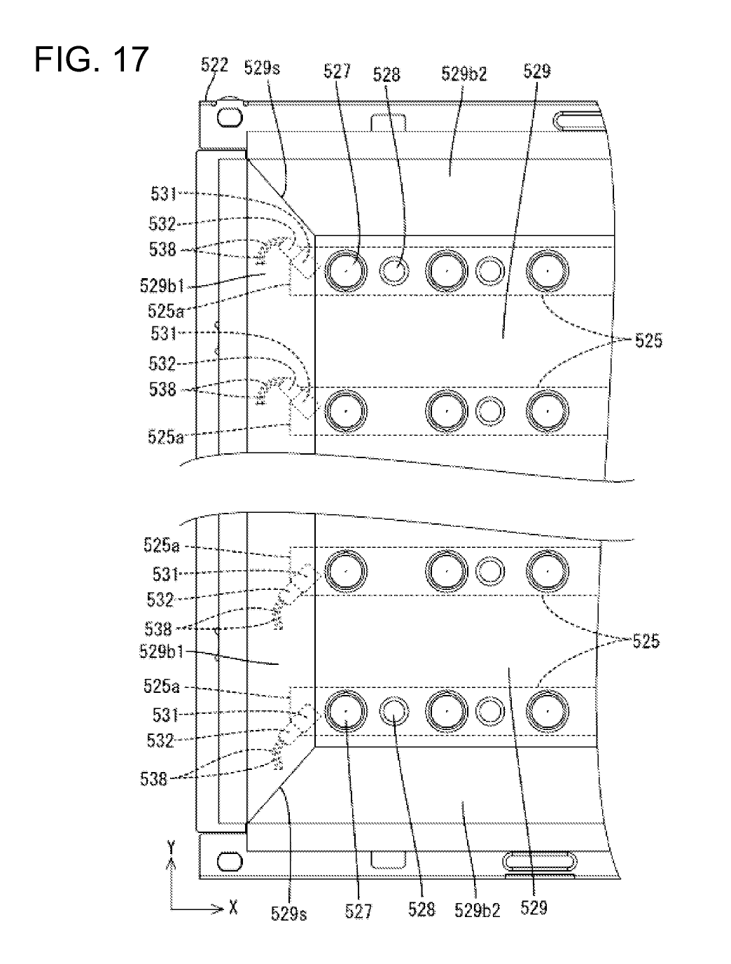

Here, first inclined sections 529b1 and second inclined sections 529b2 of a reflective sheet 529 laid over LED substrates 525 will be explained. In the backlight device of the present embodiment, respective one end faces 525a of the LED substrates 525 face the first side edges 522a1, and the second connector parts 532 are respectively disposed on end portions of the LED substrates 525 that have the one end faces 525a. Therefore, in order to secure a space to store the second connector parts 532 between the reflective sheet 529 and the side plates of the chassis 522, the second inclined sections 529b2 is inclined at a greater angle than that of the first inclined sections. Thus, the second inclined sections 529b2 are inclined at a smaller inclination angle than that of the first inclined sections 529b1. As shown in FIG. 17, the respective second connector parts (top and bottom second connector parts in FIG. 17) 532 positioned closest to the respective second side edges 522a2 are disposed between the first inclined section 529b1 and the side plate without going over boundaries 529s between the first inclined sections 529b1 and the second inclined sections 529b2. This makes it possible to prevent a part of the second connector part 532 from making contact with the first inclined section 529b1.

### Embodiment 7

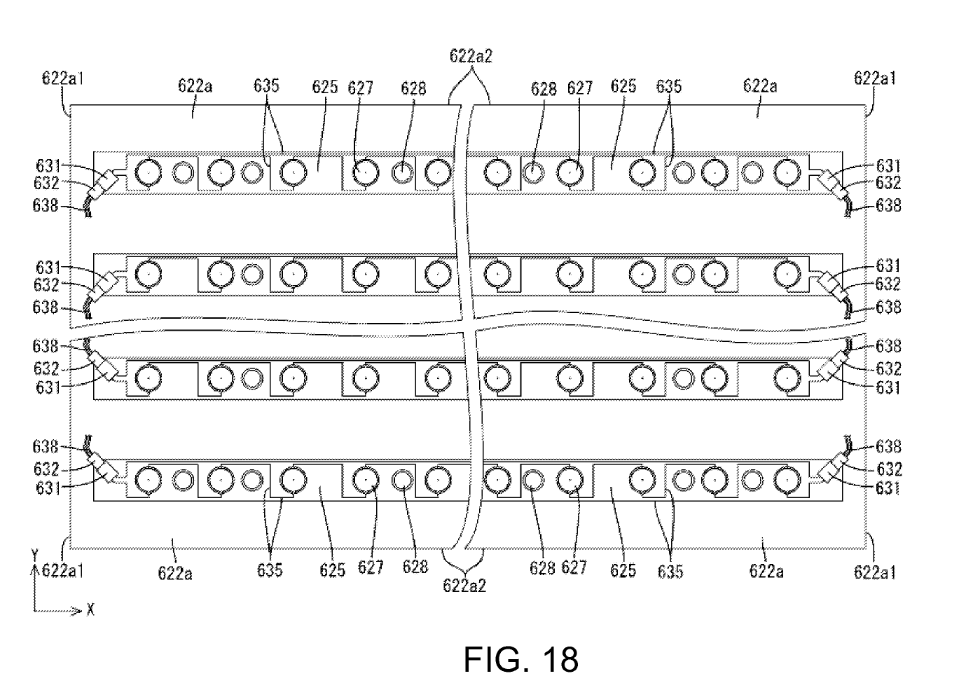

Embodiment 7 will be described with reference to the drawings. Embodiment 7 differs from Embodiment 5 in the connecting direction in which second connector parts 632 are connected to first connector parts 631. Other configurations are similar to those of Embodiment 5, and therefore, descriptions of the configurations, the operation, and the effect will be omitted. Parts in FIG. 18 that have 200 added to the reference characters of FIG. 14 are the same as these parts described in Embodiment 5.

As shown in FIG. 18, in the backlight device of Embodiment 7, the respective second connector parts 632 are connected to the respective first connector parts 631 in connecting directions that are, in a plan view, directed from respective first side edges 622a1 that face respective one end faces 625a of LED substrates 625 toward end portions of the LED substrates 625 that have the one end faces 625a at an acute angle with respect to the first side edges 622a1. The connecting directions are also directed from the center of a bottom plate 622a in the short side direction toward respective second side edges 622a2. In a manner similar to Embodiment 3, wiring insertion openings are disposed near the center portion of the bottom plate 622 in the short side direction. Thus, in the backlight device of Embodiment 7, in a manner similar to Embodiment 3, power supply wiring lines 638 can be drawn to the center of the bottom plate 622a in the short side direction with ease, and the power supply wiring lines 638 can be inserted through the wiring insertion openings formed near the center of the bottom plate 622a. In a manner similar to Embodiment 3, this makes it possible to respectively move the pair of second side edges 622a2 closer to the LED substrates 625 (inner side; toward the center of the bottom plate 622a in the short side direction), and therefore, the distance between the LED substrates 625 and the side plates that rise from the second side edges 622a2 can be reduced.

### Embodiment 8

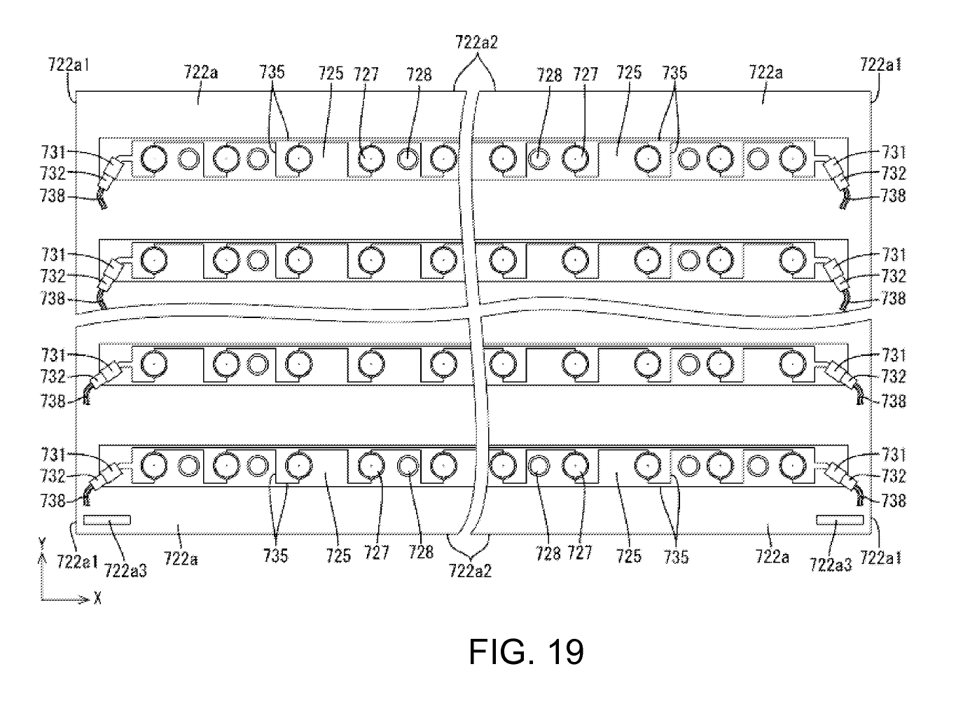

Embodiment 8 will be described with reference to the drawings. Embodiment 8 differs from Embodiment 5 in the connecting direction in which second connector parts 732 are connected to first connector parts 731. Other configurations are similar to those of Embodiment 5, and therefore, descriptions of the configurations, the operation, and the effect will be omitted. Parts in FIG. 19 that have 300 added to the reference characters of FIG. 14 are the same as these parts described in Embodiment 5.

As shown in FIG. 19, in the backlight device of Embodiment 8, wiring insertion openings 722a3 are disposed near one of second side edges 722a2 of a bottom plate 722. The respective second connector parts 732 are connected to the respective first connector parts 731 in connecting directions that are directed from respective first side edges 722a1 that face respective one end faces 725a of LED substrates 725 toward the one end faces 725a at an acute angle with respect to the first side edges 722a1 in a plan view, the directions also being directed from the second side edge 722a2 where the wiring insertion openings 722a3 are disposed toward the other second side edge 722a2. The above-mentioned acute angle is adjusted in accordance with the distance from the second side edge 722a2 where the wiring insertion openings 722a3 are disposed. Specifically, the second connector parts 732 are connected to the first connector parts 731, respectively, such that the acute angle becomes smaller as the distance from the second side edge 722a2 where the wiring insertion openings 722a3 are disposed is greater. The further away the power supply wiring lines are from the wiring insertion openings 722a3, the more strongly the wiring lines are drawn toward the wiring insertion openings 722a3. In the backlight device of Embodiment 8, because the angle of the connecting direction is adjusted in accordance with the distance from the wiring insertion openings 722a3, it is possible to prevent an excessive force from being applied to portions of the power supply wiring lines 738 that are further away from the wiring insertion openings 722a3. As a result, in the manufacturing process of the backlight device, the power supply wiring lines 738 can be drawn to the wiring insertion openings 722a3 with greater ease.

### Embodiment 9

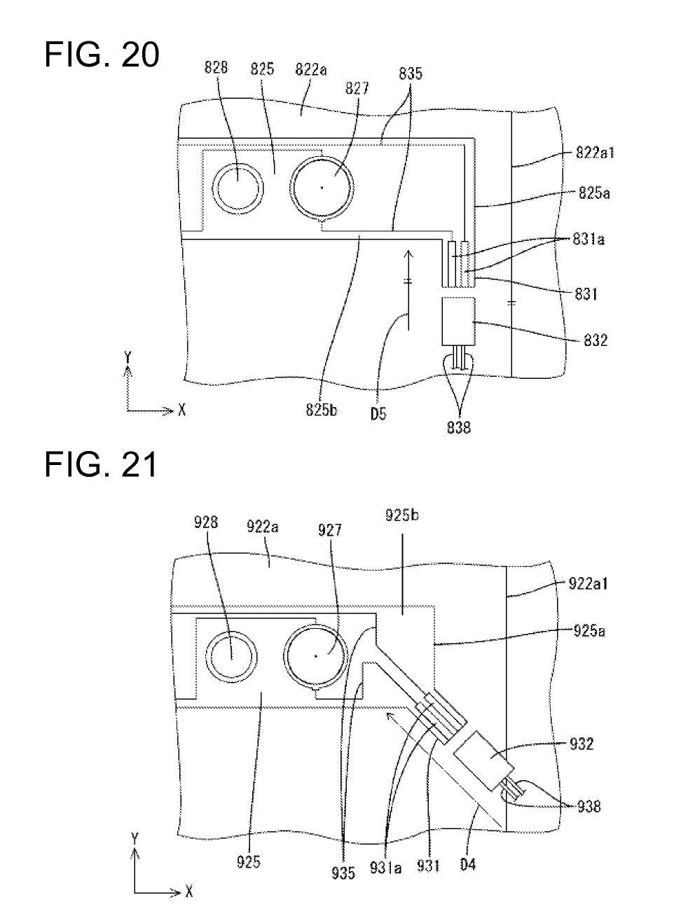

Embodiment 9 will be described with reference to the drawings. Embodiment 9 differs from Embodiment 1 in the configuration and connecting direction of the connecting members. Other configurations are similar to those of Embodiment 1, and therefore, descriptions of the configurations, the operation, and the effect will be omitted. Parts in FIG. 20 that have 800 added to the reference characters of FIG. 10 are the same as these parts described in Embodiment 1.

As shown in FIG. 20, in the backlight device of Embodiment 9, a terminal (one example of a first connecting member) 831 that is in a rectangular shape in a plan view extends from, of respective end portions of an LED substrate 825 in the long side direction, an end portion 825b that has one end face 825a facing a first side edge 822a1 of a bottom plate 822a of a chassis. On the terminal 831, exposed electrode terminals 831a are disposed, and respective ends of a wiring pattern 835 formed on the LED substrate 825 are electrically connected to the electrode terminals 831a.

To the terminal 831, a card connector (one example of the second connecting member) 832 in a rectangular shape in a plan view as shown in FIG. 20 is connected. The card connector 832 is electrically connected to the terminal 831 in a connecting direction D5 that is a direction along the plane of the bottom plate 822a and that is a direction, in a plan view, directed from one second side edge 22a2 of the bottom plate 822a toward the other second side edge 922a2 (from the lower side toward the upper side of FIG. 20), in parallel with a first side edge 822a1 of the bottom plate 822a. Power supply wiring lines 838 are electrically connected to the card connector 832, and extend from the side face of the card connector 832 on the side opposite to the side face to be connected to the terminal 831.

On both edges of the card connector 832, not-shown guide grooves are formed. The guide grooves can engage respective edges of the terminal 831, which makes it possible to slide the card connector 832 with the guide grooves and the terminal 831 engaging each other. The card connector 832 has a not-shown metal terminal therein. By making the guide grooves of the card connector 832 engage the respective edges of the terminal 831, and by sliding the card connector 832 in the direction D5 along the guide grooves, the metal terminal in the card connector 832 makes contact with the electrode terminals, thereby electrically connecting the terminal 831 to the card connector 832. Also, by sliding the card connector 832 in the direction D5 along the guide grooves, the card connector 832 is positioned on the surface of the terminal 831 (both are disposed in the same position in a plan view), and the card connector 832 is affixed to the terminal 831. Even with this configuration, the distance between the first side edge 822a1 of the bottom plate 822a and the one end face 825a of the LED substrate 825 can be reduced as compared with the case in which the card connector 832 is placed on the side of the one end face 825a that faces the first end face 822a1, and thus, it is possible to achieve a narrower frame region in the backlight device.

### Embodiment 10

Embodiment 10 will be described with reference to the drawings. Embodiment 10 differs from Embodiment 9 in the connecting direction of the connecting members. Other configurations are similar to those of Embodiment 9, and therefore, descriptions of the configurations, the operation, and the effect will be omitted. Parts in FIG. 21 that have 100 added to the reference characters of FIG. 20 are the same as these parts described in Embodiments 1 and 9.

As shown in FIG. 21, in the backlight device of Embodiment 10, a terminal 931 in a rectangular shape in a plan view extends from one end portion 925b of an LED substrate 925 in a manner similar to Embodiment 9. Also, in a manner similar to Embodiment 9, electrode terminals 931a are disposed on the terminal 931, and a card connector 932 in a rectangular shape in a plan view is connected to the terminal 931. Furthermore, in a manner similar to Embodiment 9, not-shown guide grooves are formed at respective edges of the card connector 932, and a not-shown metal terminal is disposed inside the card connector 932. In the present embodiment, the card connector 932 is connected to the terminal 931 in the same connecting direction as the connecting direction D4 between the first connector part 431 and the second connector part 432 in Embodiment 5. That is, by sliding the card connector 932 in the direction D4 along the guide grooves, the card connector 932 is positioned on the surface of the terminal 931 (both are disposed in the same position in a plan view), and the card connector 932 is affixed to the terminal 931. Even with this configuration, the distance between the first side edge 922a1 of the bottom plate 922a and the one end face 925a of the LED substrate 925 can be reduced as compared with the case in which the card connector 932 is placed on the side of the one end face 925a that faces the first end face 922a1, and thus, it is possible to achieve a narrower frame region in the backlight device.

Modification examples of the respective embodiments above will be described below.

(1) In the respective embodiments above, the configuration in which the first connector parts and the second connector parts are rectangular in a plan view was described as an example, but the shape, configuration, and the like of the first connector parts and the second connector parts are not limited. For example, it is possible to employ a configuration in which the respective connector parts are formed in a flat shape, and by sliding one connector part toward the other along the plane, the respective connector parts are connected to each other.

(2) In the respective embodiments above, the configuration in which one end faces of LED substrates face side plates that rise from first side edges of the chassis was described as an example, but it is also possible to employ a configuration in which one end faces of LED substrates face side plates that rise from second side edges of the chassis. In the respective embodiments above, the configuration in which the LED substrate is a horizontally long rectangle with the short side matching the first side edge and the long side matching was described as an example, but there is no special limitation on the shape, arrangement, quantity, and the like of the LED substrates.

(3) In the respective embodiments above, the configuration in which LEDs are disposed on each LED substrate in a row along the long side direction (X axis direction) of the chassis was described as an example, but there is no special limitation on the shape, arrangement, quantity, and the like of the LEDs. For example, the LEDs may be arranged in a row along the short side direction (Y axis direction) of the chassis.

(4) In the respective embodiments above, the configuration in which an end face of an LED substrate is a flat surface was described as an example, but the end face of the LED substrate may also be formed as a rounded curved face. In the respective embodiments above, the configuration in which an end face of an LED substrate is parallel to the first side edge (side plate that rises from that side edge) was described as an example, but the end face does not have to be parallel thereto.

(5) In addition to the respective embodiments above, the connecting direction in which the second connector parts are connected to the respective first connector parts may be appropriately changed.

(6) In addition to the respective embodiments above, the arrangement, shape, and the like of the wiring insertion openings may be appropriately changed.

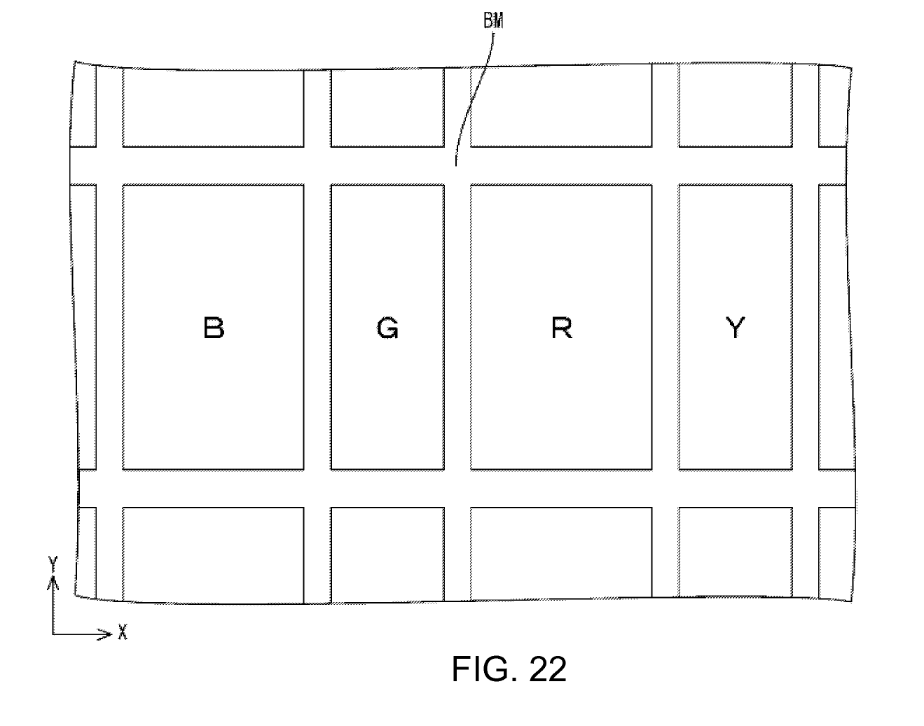

(7) In addition to the respective embodiments above, the arrangement order of the respective colored portions R, G, B, and Y in the color filters may be appropriately changed. As shown in FIG. 22, for example, the blue colored portion B, the green colored portion G, the red colored portion R, and the yellow colored portion Y may be arranged in this order from the left side of the figure along the X axis direction.

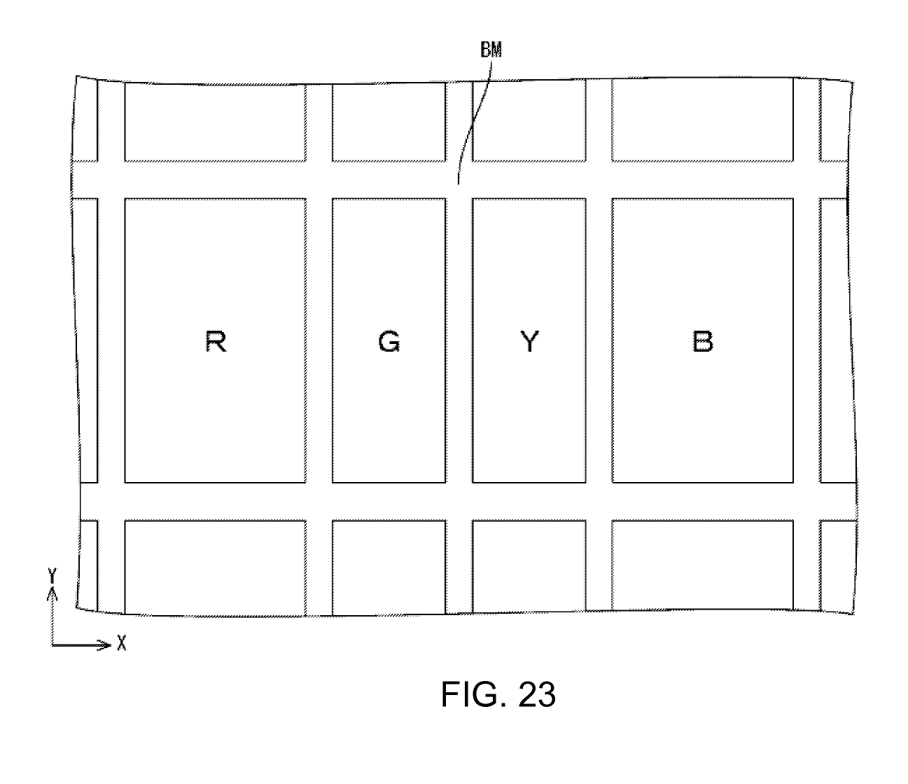

(8) In addition to the configuration of (7), as shown in FIG. 23, for example, the respective colored portions R, G, B, and Y in the color filters may be arranged in order of the red colored portion R, the green colored portion G, the yellow colored portion Y, and the blue colored portion B from the left side of the figure along the X axis direction.

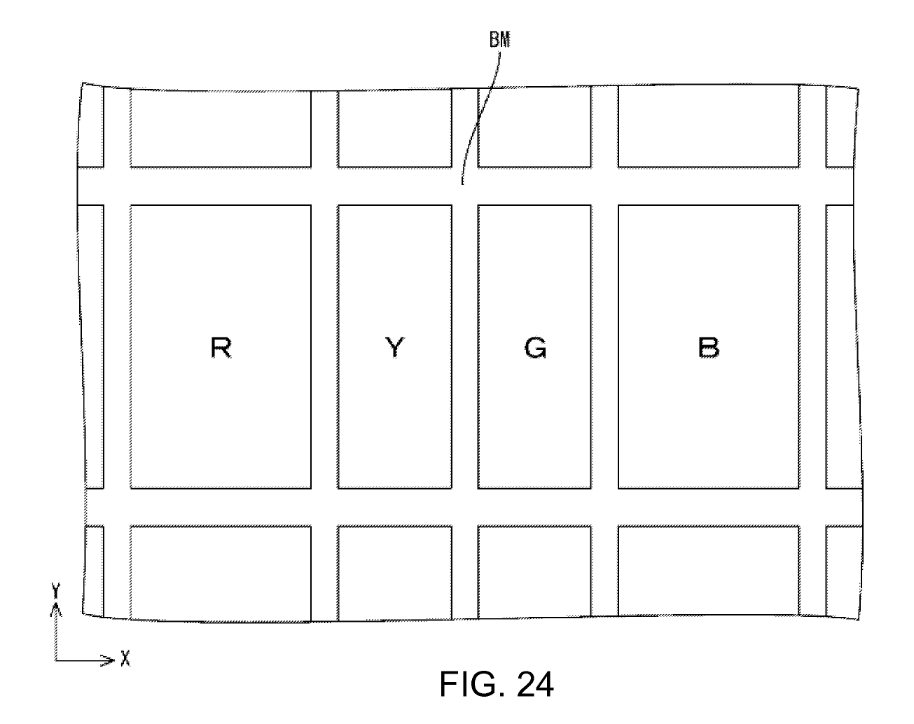

(9) In addition to the configurations of (7) and (8), as shown in FIG. 24, for example, the respective colored portions R, G, B, and Y in the color filters may be arranged in order of the red colored portion R, the yellow colored portion Y, the green colored portion G, and the blue colored portion B from the left side of the figure along the X axis direction.

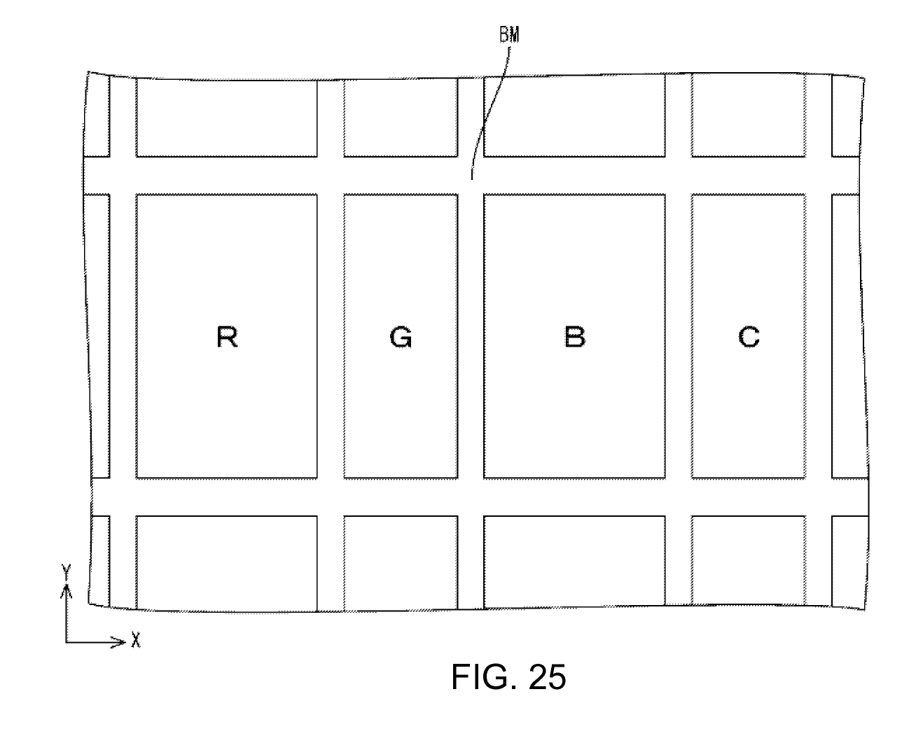

(9) In the respective embodiments above, the colored portions of the color filters were configured to have yellow (Y), in addition to red (R), green (G), blue (B), which are the three primary colors of light, but as shown in FIG. 25, it is also possible to add cyan colored portions C, instead of the yellow colored portions.

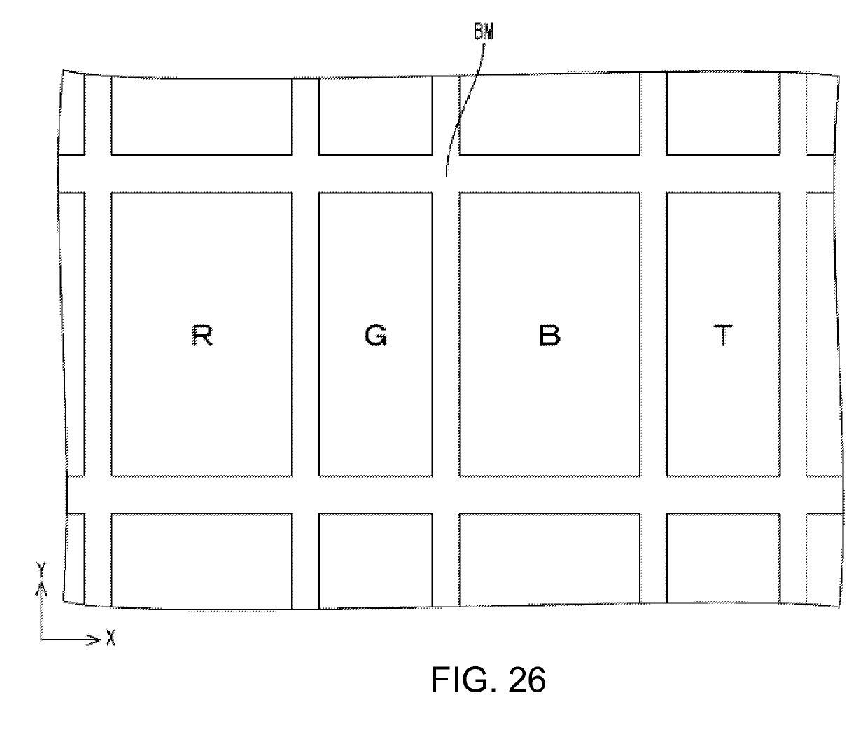

(10) In the respective embodiments above, the colored portions of the color filters had four colors, but as shown in FIG. 26, it is also possible to dispose transmissive portions T that do not color the transmitted light in place of the yellow colored portions. The transmissive portions T transmit the entire wavelength of at least visible light in an equal manner, and thus do not color the transmitted light to a specific color.

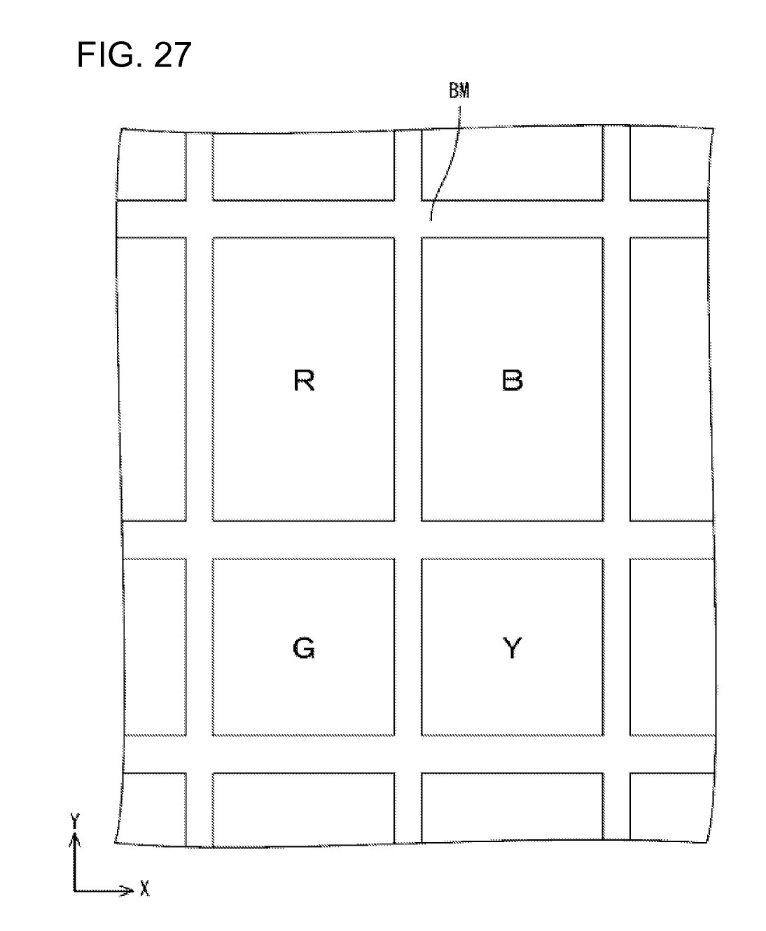

(11) In the respective embodiments above, the configuration in which the colored portions of four colors R, G, B, and Y that constitute the color filters are arranged along the row direction was described as an example, but it is also possible to arrange the colored portions of four colors R, G, B, and Y in the row and column directions. Specifically, as shown in FIG. 27, the colored portions of four colors R, G, B, and Y are arranged in a matrix with the X direction being the row direction and the Y direction being the column direction, and while the dimension of the respective colored portions R, G, B, and Y in the row direction (X axis direction) is the same, the colored portions R, G, B, and Y that are disposed in adjacent rows have different dimensions in the column direction (Y axis direction) from each other. In the row with the relatively large column direction dimension, the red colored portion R and the blue colored portion B are disposed adjacent to each other along the row direction, and in the row with the relatively small column direction dimension, the green colored portion G and the yellow colored portion Y are disposed adjacent to each other along the row direction. That is, second rows with the relatively small column direction dimension in which the red colored portions R and the blue colored portions B are alternately arranged in the row direction alternate with each other in the column direction. Accordingly, the area of the red colored portion R and the blue colored portion B is larger than the area of the green colored portion G and the yellow colored portion Y. The green colored portion G is disposed adjacent to the red colored portion R in the column direction, and the yellow colored portion Y is disposed adjacent to the blue colored portion B in the column direction.

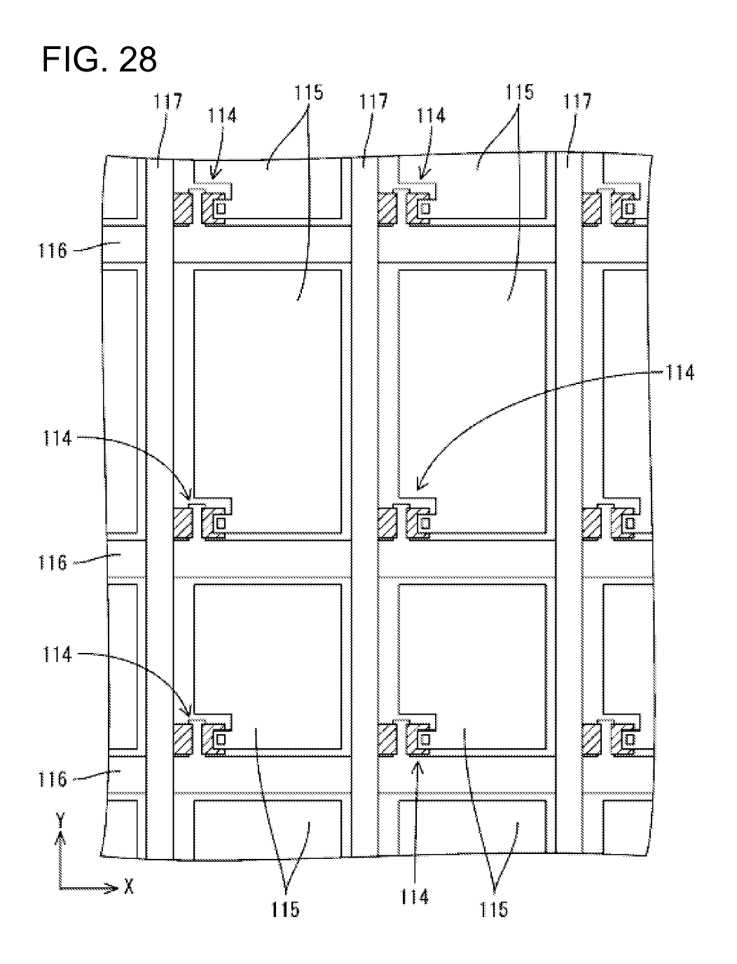

Because of the above-mentioned configuration of the color filters, as shown in FIG. 28, the array substrate is configured such that the respective pixel electrodes disposed in adjacent rows have different column direction dimensions from each other. That is, among the respective pixel electrodes, the area of pixel electrodes that respectively face the red colored portions R and the blue colored portions B is larger than the area of pixel electrodes that respectively face the yellow colored portions Y and the green colored portions G. The film thicknesses of the respective colored portions R, G, B, and Y are the same as each other. The source wiring lines are disposed at the same pitch as each other, but the gate wiring lines are arranged at two different pitches corresponding to the column direction dimensions of the pixel electrodes. FIGS. 27 and 28 show a case in which the area of the red colored portions R and the blue colored portions B is approximately 1.6 times larger than the area of the yellow colored portions Y and the green colored portions G.

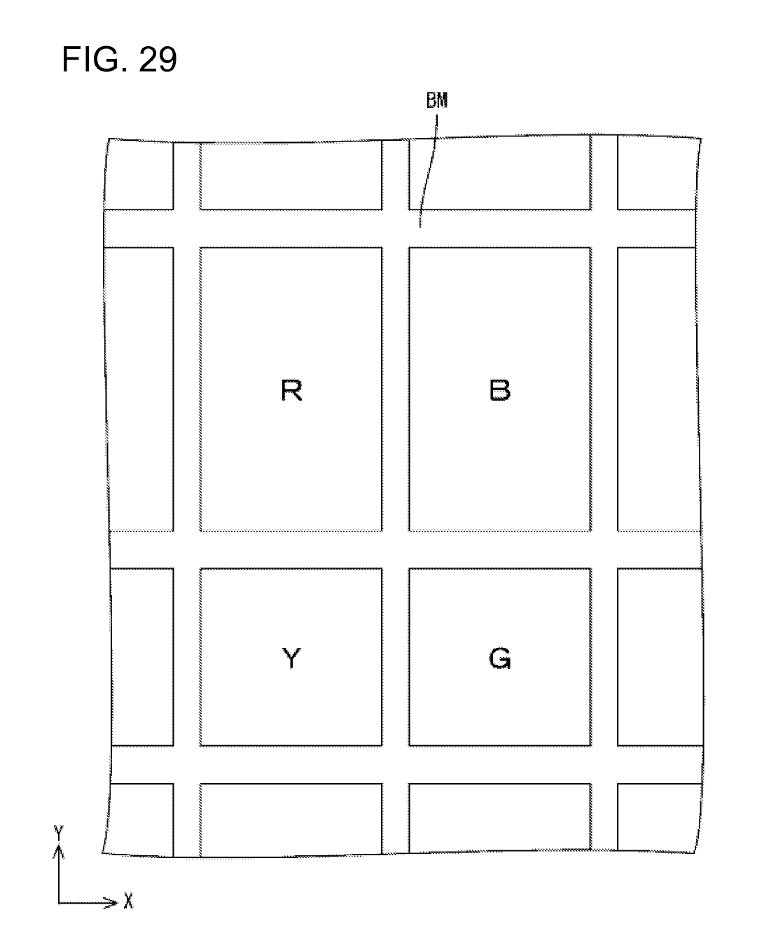

(13) As another modification example of the above-mentioned (12), as shown in FIG. 29, it is also possible to employ a configuration in which the yellow colored portion Y is disposed adjacent to the red colored portions R in the column direction, and the green colored portion G is disposed adjacent to the blue colored portion B in the column direction.

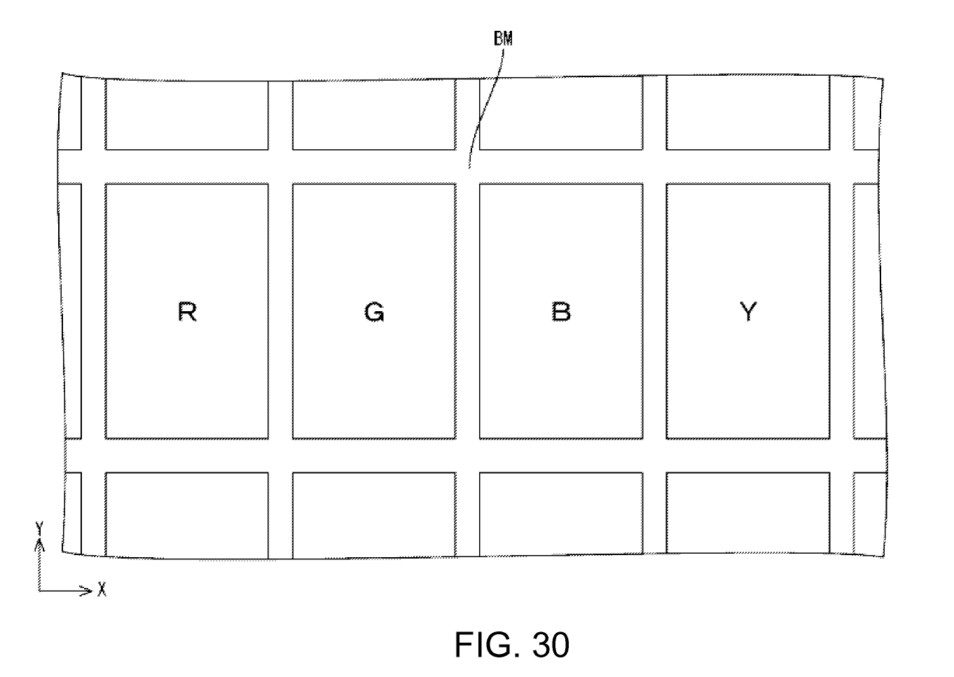

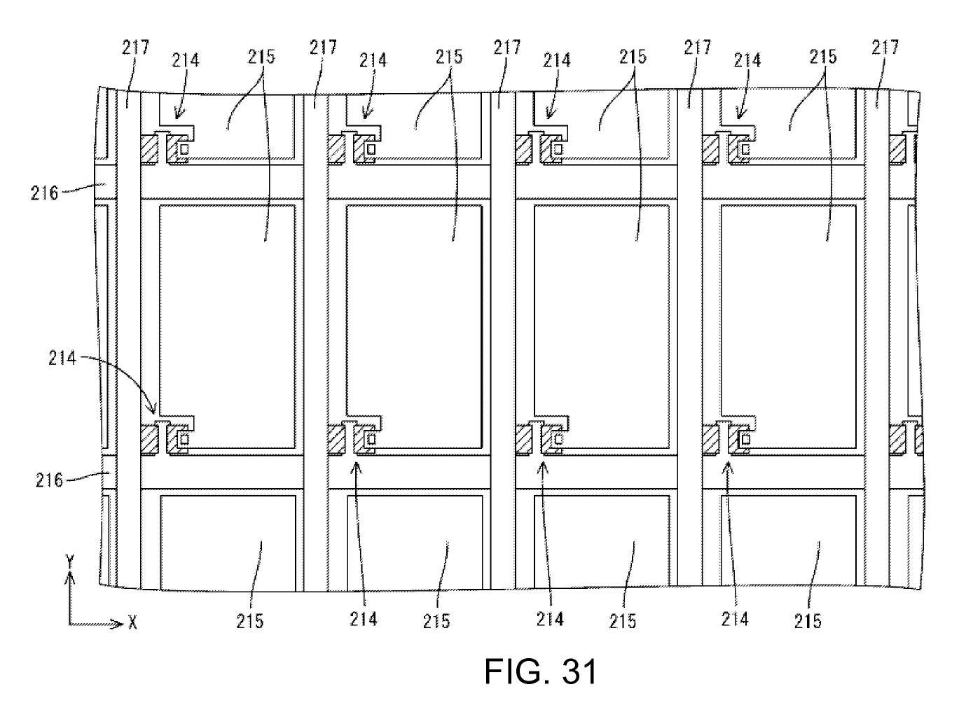

(14) In the respective embodiments above, the configuration in which the areas of the respective colored portions R, G, B, and Y that constitute the color filters are different from each other was described as an example, but it is also possible to configure the respective colored portions R, G, B, and Y such that the area thereof is the same as each other. Specifically, as shown in FIG. 30, the respective colored portions R, G, B, and Y are arranged in a matrix with the X axis direction being the row direction and the Y axis direction being the column direction, and the dimension of the respective colored portions R, G, B, and Y in the row direction (X axis direction) and in the column direction (Y axis direction) is the same as each other. Accordingly, all of the respective colored portions R, G, B, and Y have the same area. Because of the above-mentioned configuration of the color filters, as shown in FIG. 31, the array substrate is configured such that the respective pixel electrodes that face the respective colored portions R, G, B, and Y have the same dimensions in the row direction and in the column direction, thereby making all of the pixel electrodes have the same shape and the same area. The gate wiring lines and the source wiring lines are arranged at the same pitch as each other, respectively.

(15) In the above-mentioned (14), it is also possible to arrange the respective colored portions R, G, B, and Y in a manner similar to the above-mentioned (5) to (7).

(16) It is also possible to apply the configurations described in the above-mentioned (10) and (11) to the configurations described in the above-mentioned (12) and (14), respectively.

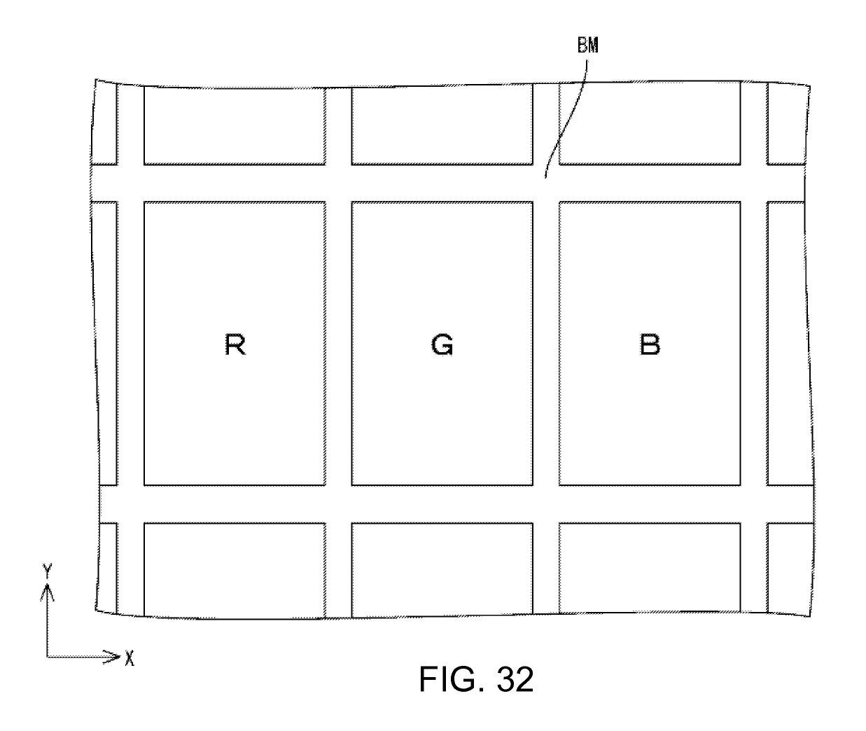

(17) In the respective embodiments above, the colored portions of the color filters had four colors, but as shown in FIG. 32, it is also possible to only have red (R), green (G), and blue (B), which are the three primary colors of light, omitting the yellow colored portions. In such a case, it is preferable that the area of the respective colored portions R, G, and B be the same as each other.

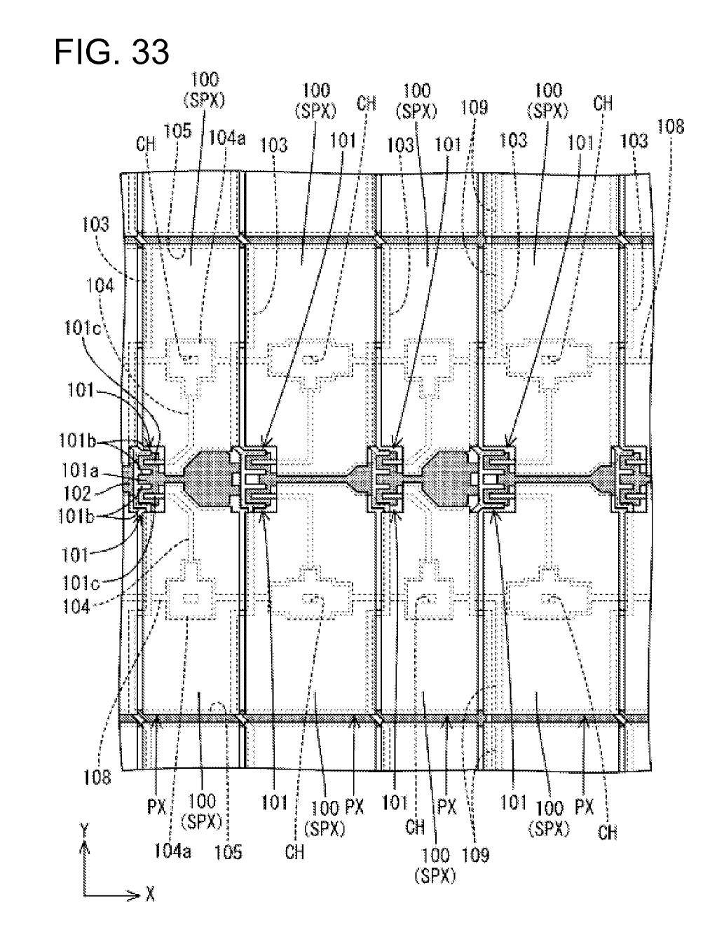

(18) In the respective embodiments above, the configuration of the pixels was described with reference to simplified figures (FIGS. 4 and 5), but in addition to the configuration disclosed in these figures, the specific configuration of the pixels can be modified. For example, the present invention can also be applied to the configuration that conducts so-called multi-pixel driving in which each pixel is divided into a plurality of subpixels, and these subpixels are driven such that gradation values thereof are made different from each other. As shown in FIG. 33, in the specific configuration thereof, one pixel PX is constituted of a pair of subpixels SPX, and the pair of subpixels SPX are constituted of a pair of pixel electrodes 100 adjacent to each other across a gate wiring line 102. On the other hand, on the gate wiring line 102, a pair of TFTs 101 is formed for the pair of pixel electrodes 100. The pair of TFTs 101 include a gate electrode 101a made of a part of the gate wiring line 102; two pairs of source electrodes 101b each made of a pair of branching lines branching out from the source wiring line 103 and disposed on the gate electrode 101a; a pair of drain electrodes 101c each formed at one end of a drain wiring line 104 that has a contact portion 104 connected to a pixel electrode 100 at the other end, each of the drain electrodes 101c being disposed on the gate electrode 101a and positioned between the pair of source electrodes 101b. The pair of TFTs 101 is arranged on the gate wiring line 102 along the direction in which the pixel electrodes 100 are arranged (Y axis direction). On the other hand, at the pair of the pixel electrodes 100, an auxiliary capacitance wiring line 105 is disposed at an end of each pixel electrode on the side opposite to the gate wiring line 102 so as to overlap each pixel electrode in a plan view, and the auxiliary capacitance wiring line 105 forms a capacitance with the corresponding pixel electrode 100. In other words, the respective two pixel electrodes 100 constituting one pixel PX form capacitance with the different auxiliary capacitance wiring lines 105. During the driving, the pair of TFTs 101 is supplied with a scan signal and a data signal from the common gate wiring line 102 and source wiring line 103, respectively, while the respective auxiliary capacitance wiring lines 105 that respectively overlap the two pixel electrodes 100 are applied with signals (potentials) that differ from each other, thereby allowing the voltage values charged into the subpixels SPX, or in other words, the gradation values, to be made to differ from each other. In this way, the so-called multi-pixel driving is realized, and it is possible to achieve excellent viewing angle characteristics.

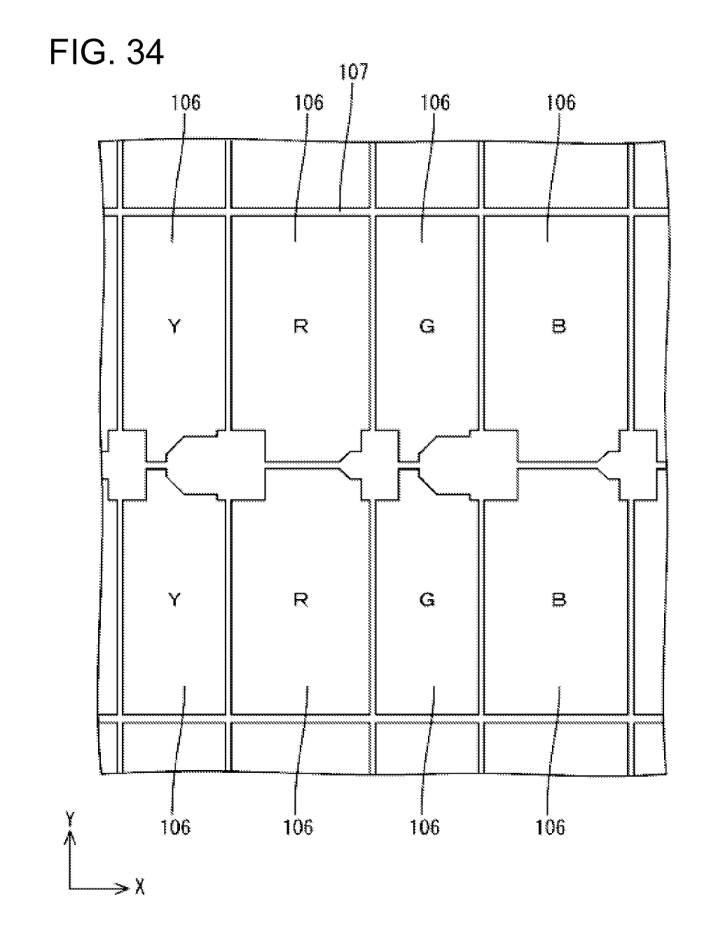

In the pixel configuration for conducting the above-mentioned multi-pixel driving, the respective pixel electrodes 100 and the respective colored portions R, G, B, and Y in the color filters 106, which face the respective pixel electrodes 100, have the following configuration. That is, as shown in FIG. 34, the color filters 106 are constituted of colored portions of four colors R, G, B, and Y, and the yellow colored portion Y, the red colored portion R, the green colored portion G, and the blue colored portion B are repeatedly arranged in a row in this order from the left side of the figure along the X axis direction. The respective colored portions R, G, B, and Y are divided by a light-shielding layer (black matrix) 107, and the light-shielding layer 107 is arranged in a substantially grid pattern, overlapping the gate wiring lines 102, the source wiring lines 103, and the auxiliary capacitance wiring lines 105 in a plan view. Among the respective colored portions R, G, B, and Y, while the yellow colored portions Y and the green colored portions G have substantially the same dimension as each other with respect to the X axis direction (direction in which the colored portions R, G, B, and Y are arranged), the dimension of the red colored portions R and the blue colored portions B along the X axis direction is relatively large compared to that of the yellow colored portions Y and the green colored portions G (approximately 1.3 times to 1.4 times larger, for example). More specifically, the dimension of the red colored portions R along the X axis direction is slightly larger than that of the blue colored portions B. As shown in FIG. 33, the respective pixel electrodes 100 have substantially the same size as each other with respect to the Y axis direction, but with respect to the X axis direction, the pixel electrodes 100 have the sizes that correspond to the sizes of the colored portions R, G, B, and Y of the color filters 106 that face the respective pixel electrodes 100.

Embodiments of the present invention were described above in detail, but these are merely examples, and do not limit the scope defined by the claims. The technical scope defined by the claims includes various modifications of the specific examples described above.

Also, the technical elements described in the present specification or shown in the drawings realize technical utility each on their own or through a combination of various technical elements, and are not limited to the combinations defined by the claims at the time of filing. Also, the techniques described in the present specification or shown in the drawings can accomplish a plurality of objects simultaneously, and each one of the objects on its own has technical utility.

### DESCRIPTION OF REFERENCE CHARACTERS

TV television receiver
Ca, Cb cabinet
T tuner
VC image conversion circuit substrate
S stand
10 liquid crystal display device
11 liquid crystal panel
12 backlight device
13 bezel
22 chassis
22a, 122a, 222a, 322a, 422a, 522a, 622a, 722a, 822a, 922a bottom plate
24 LED
25, 125, 225, 325, 425, 525, 625, 725, 825, 925 LED substrate
26 frame
27, 127, 227, 327, 427, 527, 627, 727, 827, 927 diffusion lens
31, 131, 231, 331, 431, 531, 631, 731 first connector part
32, 132, 232, 332, 432, 532, 632, 732 second connector part
35, 135, 235, 335, 435, 535, 635, 735, 835, 935 wiring pattern
38, 138, 238, 338, 438, 538, 638, 738, 838, 938 power supply wiring line
831, 931 terminal
832, 932 card connector

1. An illumination device, comprising:
a housing member that has a bottom plate and a side plate that rises from at least one of side edges of said bottom plate, the housing member having an aperture on top to transmit light;
a light source substrate disposed on the bottom plate of the housing member such that one end face of the light source substrate faces the side plate;
light sources disposed on the light source substrate such that light is emitted upward;
patterned wiring disposed on the light source substrate and electrically connected to the light sources;
a first connecting member electrically connected to the patterned wiring and disposed on, of end portions of the light source substrate, an end portion that has said one end face;
a second connecting member electrically connected to the first connecting member in a connecting direction along a plane of the bottom surface, the connecting direction also being, in a plan view, a direction parallel to the side edge of the bottom plate where the side plate facing said one end face is disposed, or a direction directed from said side edge toward said end portion of the light source substrate at an acute angle with respect to said side edge; and
a power supply wiring line electrically connected to the second connecting member and supplying power to the light sources through the second connecting member, the first connecting member, and the patterned wiring.

2. The illumination device according to claim 1, wherein the bottom plate has a horizontally long rectangular shape, and the side edges are made of a pair of first side edges along a short side direction of the bottom plate and a pair of second side edges along a long side direction of the bottom plate,
wherein a plurality of said light source substrates are disposed on the bottom surface, and the respective one end faces of the light source substrates face the side plates that rise from the first side edges, respectively,
wherein the plurality of light source substrates each have the first connecting member disposed thereon, and
wherein a plurality of said first connecting members each have the second connecting member connected thereto.

3. The illumination device according to claim 2, wherein all of a plurality of said second connecting members are connected to the respective first connecting members in the same connecting direction as each other.

4. The illumination device according to claim 2, wherein the plurality of light source substrates are aligned along the short side direction of the bottom plate, and
wherein a plurality of said second connecting members are connected to the respective first connecting members in connecting directions from the respective second side edges toward a center of the bottom plate in the short side direction.

5. The illumination device according to claim 2, wherein the plurality of light source substrates are aligned along the short side direction of the bottom plate, and
wherein a plurality of said second connecting members are connected to the respective first connecting members in connecting directions from a center of the bottom plate in the short side direction toward the respective second side edges.

6. The illumination device according to claim 2, wherein a plurality of said second connecting members are connected to the respective first connecting members in a connecting direction directed from one side edge toward another side edge of the pair of second side edges, and the connecting direction is adjusted in accordance with a distance from said one side edge.

7. The illumination device according to claim 1, further comprising diffusion lenses disposed on each of the plurality of light source substrates, the diffusion lenses covering light-emitting sides of the respective light sources and diffusing light from the source sources.

8. The illumination device according to claim 7, further comprising a reflective sheet that has a bottom section laid over the light source substrates, lens insertion holes disposed in the bottom section and having the diffusion lenses respectively inserted therethrough, and inclined sections that rise upward near the side plates of the housing member,
wherein, among a plurality of said second connecting members, the second connecting members that are respectively closest to the second side edges are positioned between the reflective sheet and the side plates that rise from the first side edges.

9. The illumination device according to claim 8, wherein the bottom section of the reflective sheet is formed in a horizontally long rectangular shape, and is placed on the light source substrates such that short sides thereof extend along the first side edges and long sides thereof extend along the second side edges,
wherein the inclined sections of the reflective sheet include first inclined sections that rise from outer edges along the short sides of the bottom section upward, and second inclined sections that rise from outer edges along the long sides of the bottom section upward, and
wherein, among the plurality of second connecting members, second connecting members that are respectively closest to the second side edges are positioned between the first inclined sections of the reflective sheet and the side plates that rise from the first side edges.

10. The illumination device according to claim 1, wherein the acute angle is in a range of 30° to 60°.

11. The illumination device according to claim 1, wherein the light sources are white light-emitting diodes.

12. The illumination device according to claim 11, wherein the white light-emitting diodes are each made of any one of combinations that include: a combination of a first light-emitting chip that emits blue light and a first light-emitting layer disposed around the first light-emitting chip and having a luminescence peak in a yellow region; a combination of the first light-emitting chip that emits blue light and a second light-emitting layer disposed around the first light-emitting chip and having luminescence peaks in a green region and a red region, respectively; a combination of the first light-emitting chip that emits blue light, a third light-emitting layer disposed around the first light-emitting chip and having a luminescence peak in a green region, and a second light-emitting chip that emits red light; a combination of the first light-emitting chip that emits blue light, the second light-emitting chip that emits red light, and a third light-emitting chip that emits green light; and a combination of a fourth light-emitting chip that emits ultraviolet light, and a fourth light-emitting layer disposed around the fourth light-emitting chip and having luminescence peaks in a blue region and a red region.

13. A display device, comprising a display panel that conducts display by using light from the illumination device according to claim 1.

14. The display device according to claim 13, wherein the display panel is a liquid crystal panel that uses liquid crystal.

15. A television receiver, comprising the display device according to claim 13.
